(19) United States
(12) Patent Application Publication
(10) Pub. No.: US 2019/0088072 A1
(43) Pub. Date: Mar. 21, 2019

(54) SYSTEM, METHOD AND COMPUTER PRODUCT FOR ALLOWING A USER TO CREATE, FUND AND UTILIZE A PLAYER ACCOUNT

(71) Applicant: Respin LLC, Reno, NV (US)

(72) Inventors: Jasmin Patel, Reno, NV (US); Raymond Osborne, Sparks, NV (US); Francis Keyser, Reno, NV (US); Daniel Jacobus deWaal, Reno, NV (US)

(21) Appl. No.: 16/131,251

(22) Filed: Sep. 14, 2018

Related U.S. Application Data
(60) Provisional application No. 62/559,071, filed on Sep. 15, 2017.

(51) Int. Cl. G07F 17/32

(52) U.S. Cl. CPC G07F 17/323; G07F 17/3244

(57) ABSTRACT

System, method and computer product for a system including a database, a user module, a server system and a service device is provided. The user account includes a funding method and a payment method. The server system stores the user account including the funding method and the payment method in the database. The user module allows the user to transfer monetary funds into the user account using the payment method and allows the user to purchase credits using the monetary funds. The service device provides service(s) and/or good(s) in exchange for a predetermined number of credits. The user module allows the user to request a temporary account with an associated number of credits. The server system generates a temporary account code. The service device accepts the temporary account code, transfers the credits associated with the temporary account to the service device and responsively provides the good(s) and/or service(s).

### CROSS-REFERENCE TO RELATED APPLICATION

This application claims the benefit of U.S. Provisional Patent Application Ser. No. 62/559,071, filed Sep. 15, 2017, the disclosure of which is hereby incorporated by reference in its entirety.

### FIELD OF THE INVENTION

The present invention relates generally to electronic transactions, and more particularly, to a system, method and computer product configured to allow a user to fund and utilize a financial account to purchase services and/or goods on a service device.

### BACKGROUND OF THE INVENTION

Typical gaming systems, e.g., a gaming system located at a casino gaming environment, include a plurality of gaming machines. The gaming machines are generally stand-alone units that provide a player an opportunity to win an award based on the outcome of a game played on the gaming machine in exchange for a wager. Typically, the player adds funds to a credit meter of the gaming machine either by depositing funds or currency into the gaming machine using a bill validator or transferring funds represented on a printed ticket into a ticket reader. However, the player must either have currency or obtain a ticket, at a kiosk or at a cashier, which generally requires currency. The casino gaming environment may include one or more automatic teller machines (ATM), but there may be limits on the amount of currency that can be withdrawn during a predetermined time period.

The present invention is aimed at one or more of the problems identified above.

### SUMMARY OF THE INVENTION

In one aspect of the present invention, a system for use with a gaming system, including a plurality of gaming machines, is provided. The system includes a database, a player module, a server system and a service device. The database stores a player account. The player account includes funds associated with a player. The player module is associated with a mobile device. The server system is coupled to the database and the user module. The service device is coupled to the database and the server system and is located at, and coupled to, a respective gaming machine. The player module is configured to allow the player to logon and access the player account on the server system and to allow the player to request a first gaming session. The server system is responsively configured to open the first gaming session on the server system, to convert at least a portion of the funds in the player account to credits, and to associate the credits to the first gaming session. The player module is further configured to allow the player to request a second gaming session associated with the gaming machine, and to authenticate the request for a second gaming session associated using the service device and the player module. The server system, in response to the request being authenticated, is further configured to open the second gaming session, to associate at least a portion of the credits associated with the first gaming session to the second gaming session, and to transfer the credits transferred to the second gaming session to the gaming machine using the service device. The player may purchase service(s) and/or good(s) in exchange for a predetermined number of credits during the gaming session. The service device is further configured to close the first and second gaming sessions on the server system and to transfer any remaining credits on the gaming machine to the server system at the close of the gaming session.

In another aspect of the present invention, a method for operating a system is provided. The system includes a database, a player module associated with a mobile device, and a service device coupled to the database and the server system. The service device is located at, and coupled to, a gaming machine. The method including the steps of:

allowing the player, using the player module, to logon and access the player account on the server system and to allow the player to request a first gaming session;

in response to receiving the request to open the first gaming session, opening, by the server system, the first gaming session;

converting at least a portion of the funds in the player account to credits;

associating the credits with the first gaming session;

allowing the player to request a second gaming session on the server system associated with the gaming machine, and

authenticating the request for a second gaming session using the service device and the player module;

responsively opening, by the server system, the second gaming session;

associate at least a portion of the credits associated with the first gaming session to the second gaming session, and

transferring the credits associated with the second gaming session to the gaming machine using the service device, wherein the player may purchase service(s) and/or good(s) in exchange for a predetermined number of credits during the gaming session, the service device being further configured to close the first and second gaming sessions on the server system and to transfer any remaining credits on the gaming machine to the server system at the close of the gaming session.

In a further aspect of the present invention a system for use with a gaming system is provided. The gaming system includes a plurality of gaming machines. The system includes a database, a server system and a plurality of service device. The server system is coupled to the database and is configured to allow a player to establish a player account and to store the player account in the database. The server system is further configured to allow the player to fund the account by transferring funds into the player account and to purchase credits for use in the gaming system using the funds transferred into the player account. The transferred funds and the purchased credits are stored in the player account. The plurality of service devices are coupled to the database and the server system. Each service device is located at, and coupled to, a respective gaming machine. The service device is configured to allow the player to access the player account and to initiate a gaming session on the server system. The service device is further configured to allow the player to download credits from the player account stored in the database to purchase service(s) and/or good(s) in exchange for a predetermined number of credits during the gaming session. The service device is further configured to close the gaming session on the server system and to transfer any remaining credits on the gaming machine to the server system at the close of the gaming session. Any remaining credits are stored in the player account in the database.

In still another aspect of the present invention, a method for operating a system is provided. The system includes a database, a server system, and a plurality of service devices. The plurality of service devices are coupled to the database and the server system. Each service device is at, and coupled to, a respective gaming machine. The method includes the steps of allowing a player to establish a player account using the server system and to store the player account in the database and allowing the player to fund the account by transferring funds into the player account and to purchase credits for use in the gaming system using the funds transferred into the player account.

The transferred funds and the purchased credits are stored in the player account. The method further includes the steps of allowing the player to access the player account and to initiate a gaming session on the server system and allowing the player to download credits from the player account stored in the database to purchase service(s) and/or good(s) in exchange for a predetermined number of credits during the gaming session. The method also includes the steps of closing the gaming session on the server system, transferring any remaining credits on the gaming machine to the server system and storing the remaining credits in the player account in the database.

In another aspect of the present invention, a system including a database, a user module, a server system and a service device is provided. The user module is configured to control a processor of a user device to allow a user to establish a user account. The user account includes a funding method and a payment method. The server system is configured to be coupled to the user module and to the database and is configured to control a server processor, responsive to the user module, to store the user account including the funding method and the payment method in the database. The user module is further configured to control the processor to allow the user to transfer monetary funds into the user account using the payment method and to allow the user to purchase credits using the monetary funds. The service device is coupled to the database and is configured to provide service(s) and/or good(s) in exchange for a predetermined number of credits. The user module is further configured to control the processor to allow the user to request a temporary account with an associated number of credits. The server system is further configured to control the server processor to create the temporary account with the associated number of credits and to generate a temporary account code. The service device is further configured to accept the temporary account code, to transfer the credits associated with the temporary account from the database to the service device and to responsively provide the good(s) and/or service(s).

In another aspect of the present invention, a system including a database, a user module, a server system and a service device is provided. The user module is configured to control a processor of a user device to allow a user to: create a user account, establish a funding method associated with the user account and establish a payment method associated with the funding user method. The server system is configured to be coupled to the user module and to the database and to control a server processor, responsive to the user module, store the user account including the funding method and the payment method in the database. The user module being further configured to control the processor to allow the user to transfer monetary funds into the user account using the payment method, the server system configured to control the server processor, responsive to the user module, to store a record of the transferred monetary funds in the user account in the database. The user module is further configured to control the processor to allow the user to purchase credits using the monetary funds. The server system is also configured to control the server processor, responsive to the user module, to store a record of the purchased credits in the user account in the database. The service device is coupled to the database and configured to provide service(s) and/or good(s) in exchange for a predetermined number of credits. The user module is further configured to control the processor to allow the user to request a temporary account with an associated number of credits. The server system is further configured to control the server processor to create the temporary account with the associated number of credits and to generate a temporary account code. The service device is further configured to accept the temporary account code, to transfer the credits associated with the temporary account from the database to the service device and to responsively provide the good(s) and/or service(s).

In still another aspect of the present invention, a method for operating a system is provided. The system includes a database, a user module, a server system, and a service device. The method including the steps of allowing, by the user module, a user to establish a user account, the user account including a funding method and a payment method, storing, by the server system, the user account in the database, allowing, by the user module, the user to transfer monetary funds into the user account using the payment method, and allowing, by the user module, the user to purchase credits using the monetary funds. The method also includes the steps of allowing, by the user module, the user to request a temporary account with an associated number of credits, creating and by the server system, the temporary account with the associated number of credits and to generate a temporary account code. The method further includes the steps of accepting, by the service device, the temporary account code and transferring the credits associated with the temporary account from the database to the service device and to responsively providing the good(s) and/or service(s) in exchange for the transferred credits.

In a still further aspect of the present invention, one or more non-transitory computer-readable storage media for use with a system is provided. The system includes a database, a user module, a server system, and a service device. The one or more non-transitory computer-readable storage media have computer executable instructions embodied thereon. The computer executable instructions, when executed by one or more processors of the system, cause the one or more processors to allow, by the user module, a user to establish a user account, the user account including a funding method and a payment method, store, by the server system, the user account in the database, allow, by the user module, the user to transfer monetary funds into the user account using the payment method, allow, by the user module, the user to purchase credits using the monetary funds, and allow, by the user module, the user to request a temporary account with an associated number of credits. The computer executable instructions also cause the one or more processors to create, by the server system, the temporary account with the associated number of credits and to generate a temporary account code, to accept, by the service device, the temporary account code, and to transfer the credits associated with the temporary account from the database to the service device and to responsively provide the good(s) and/or service(s) in exchange for the transferred credits.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1A is a diagrammatical illustration of a system that allows a user to create, fund and utilize a financial account diagram, according to an embodiment of the present invention;

FIG. 1B is a diagrammatical illustration of an exemplary gaming machine connected to external systems, according to an embodiment of the present invention;

FIG. 2 is a functional block diagram of a user device, according to an embodiment of the present invention;

FIG. 3 is a functional block diagram of a server and database, according to an embodiment of the present invention;

FIG. 4 is a functional block diagram of a service device, according to an embodiment of the present invention.

FIG. 5 is a flow diagram of a first method associated with the system of FIG. 1A.

FIG. 6 is a flow diagram of a second method associated with the system of FIG. 1A.

FIG. 7 is a flow diagram of a third method associated with the system of FIG. 1A.

FIG. 8 is a flow diagram of a fourth method associated with the system of FIG. 1A.

FIG. 9 is a flow diagram of a fifth method associated with the system of FIG. 1A.

FIG. 10 is a flow diagram of a sixth method associated with the system of FIG. 1A.

FIG. 11 is a flow diagram of a seventh method associated with the system of FIG. 1A.

FIG. 12 is a flow diagram of an eighth method associated with the system of FIG. 1A.

FIG. 13 is a functional block diagram of an exemplary platform implementing one or more aspects of the present invention.

FIG. 14 is a process diagram of a service enrollment method, according to an embodiment of the present invention.

FIG. 15 is a process diagram of a credit transaction service method, according to an embodiment of the present invention.

FIG. 16 is a process diagram of a purchase service method, according to an embodiment of the present invention.

FIG. 17 is a process diagram of a credit redemption method, according to an embodiment of the present invention.

FIG. 18 is a process diagram of a credit transaction service method according to an embodiment of the present invention.

FIG. 19 is a process diagram of a purchase service method for a temporary account, according to an embodiment of the present invention.

FIG. 20 is a process diagram of a credit redemption service method for a temporary account, according to an embodiment of the present invention.

FIGS. 21-30 are process diagrams related to managing a player account, according to an embodiment of the present invention.

### DETAILED DESCRIPTION OF INVENTION

Referring to the Figs., wherein like numerals indicate like or corresponding parts throughout the several views, a system 10 and method provides a system 10, method, and computer product for allowing a user to create, fund and utilize a financial account. In general, the user may utilize funds deposited into the financial account to purchase credits which may be used to purchase good(s) and/or services(s). The good(s) and/or service(s) may be purchased via credits at a service device 12.

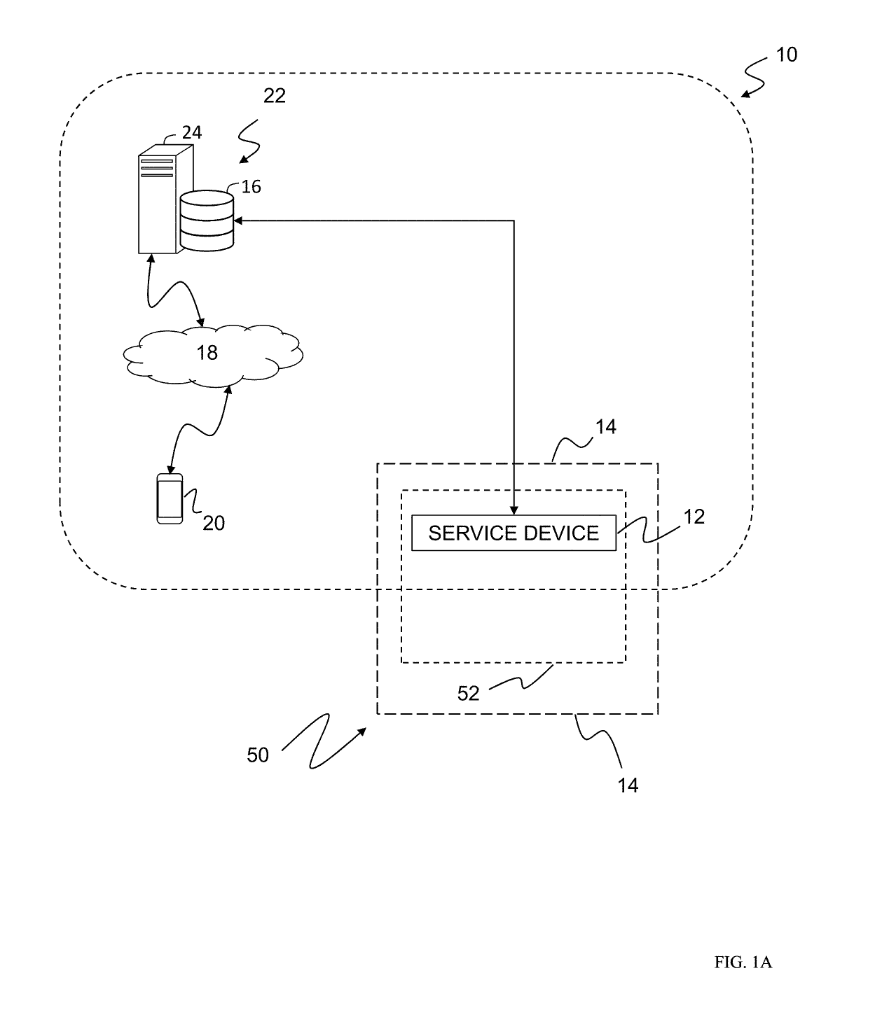

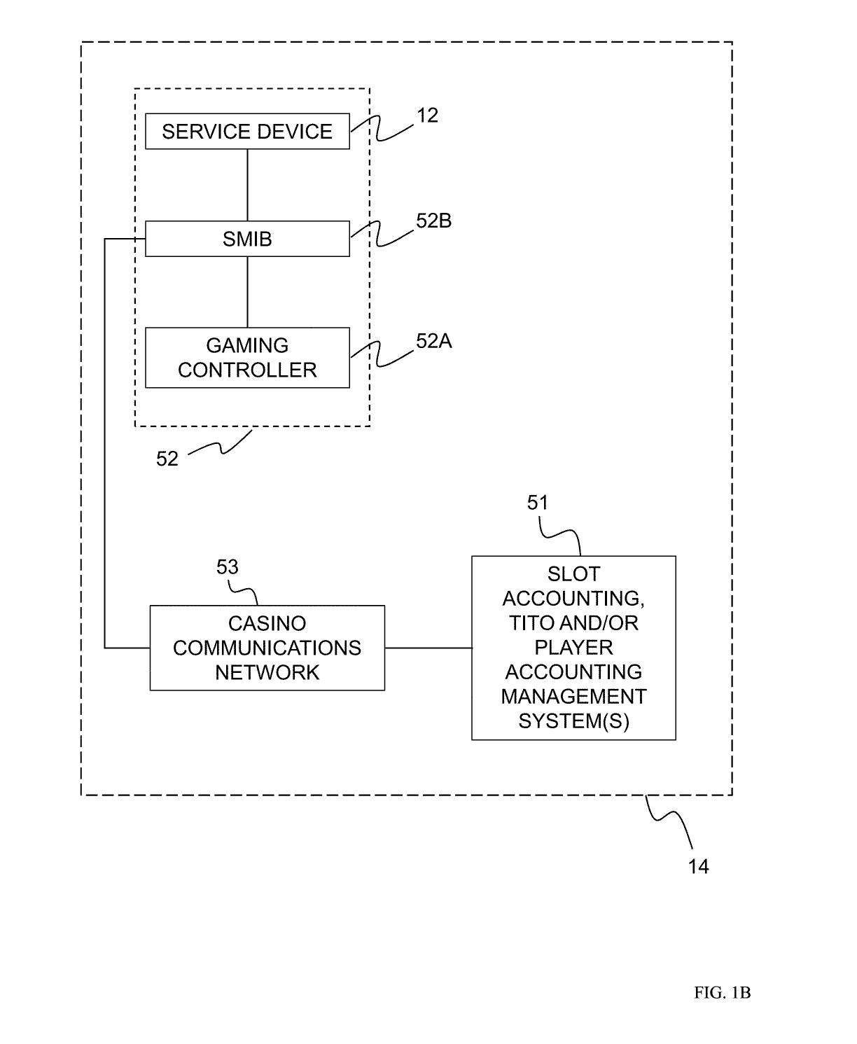

With reference to FIG. 1A, in one aspect of the present invention the system 10 may be used with a gaming system 50. The gaming system 50 may include a plurality of gaming machines 52 (only one of which is shown). The system 10 includes a database 16, a server system 22, a user module 18, and a plurality of service devices 12. The server system 22 is coupled to the database 16 and is configured to allow a player to establish a player account and to store the player account in the database 16. The server system 22 may include one or more servers 24. The database 16 may be implemented at one or more of the servers 24. The servers 24 may be located at the same or different locations. Each server 24 may include a processor or processors for running one or more software applications to implement portions of the present invention. The user or player module 18 may be implemented by an application or app running on a processor of a user or mobile device 20.

The server system 22 is further configured to allow the player to fund the account by transferring funds into the player account and to purchase credits for use in the gaming system using the funds transferred into the player account. The transferred funds and the purchased credits are stored in the player account.

The plurality of service devices 12 are coupled to the database 22 and the server system 22. Each service device 12 is associated with, and coupled to, a respective gaming machine 52. The service device 12 is configured to allow the player to access the player account and to initiate a gaming session on the server system 22. The service device 12 is further configured to allow the player to download credits from the player account stored in the database to purchase service(s) and/or good(s) in exchange for a predetermined number of credits during the gaming session. The service device 12 is further configured to close the gaming session on the server system and to transfer any remaining credits on the gaming machine to the server system 22 at the close of the gaming session. Any remaining credits are stored in the player account in the database.

For instance, the service device 12 may be coupled to a gaming machine 52 located at the gaming environment 14. The gaming environment 14 may be a casino in which the gaming machine 52 provides a game of chance and/or skill for which an outcome is generated. A user or player may be awarded an award as a function of the outcome of the game. Alternatively, the gaming environment 14 may be a casino or an arcade in which the gaming machine 52 provides a game of chance and/or skill for which an outcome is generated. An outcome may be generated, however, in one embodiment, no award is provided. Alternatively, an award, e.g., credits and/or prizes, may be generated.

A gaming machine 52 may be any type of device at which a game may be played or provided through, or at which goods or services may be provided and/or sold. Gaming machines 52 may include without limitation, stand-alone gaming machines, such as a video slot machine, a mobile computing device, a table game, or similar device; a game or service client running on a computer, mobile computing device, kiosk, or other suitable device; or a thin client executed on a computer, mobile computing device, kiosk or other suitable device. In some embodiments, the game or service client or the thin client may be running on an embedded device that allows a player to interact with a player tracking and accounting system.

In general, the service device 12 allows the player to enter, or otherwise, establish or receive, an access code from the player or user. In response to receiving the access code from the player, the service device 12 communicates with the server system 22 and sends the received access code to the server system 22. In response to receiving the access code from one of the service devices 12, the server system 22 opens a gaming session for the player on the server system 22. During the gaming session, the player may download credits from their player account in the database 14 for use on the gaming machine 52. During the gaming session, i.e., while the gaming session is open, another gaming session cannot be opened for the player on another gaming machine 52. In general, the gaming session may be closed when the player actively closes the gaming session, either on the gaming machine 52 or using the user module 18 running on the player's user device 20. The service device 12 may be provided in place or, or in addition to, one or more of the local peripheral devices.

In one aspect of the present invention, the service device 12 may be an add-on device or service process or software module running on the gaming machine 52 (or and through, and at least partly, on the gaming machine 52 in the case of a thin client acting as the gaming machine 52).

With reference to FIG. 1B, in another embodiment, the service device 12 is a computing device located at and/or coupled to a respective gaming machine 52 and to the server system 22.

As shown, in a specific embodiment in which the service device 12 is provided with at a gaming machine 52 located at a casino or gaming environment, the service device 12 may be connected to a gaming controller 52A of the gaming machine 52 via a slot machine interface board or SMIB 52B. The SMIB 52B communicates to the gaming controller 52A. The SMIB 52B provide access to onboard devices within the gaming machine 52 and allows credits to be downloaded to the gaming machine 52. In general, the SMIB 52B allows local peripheral devices, such as ticket readers/ticket printers, bill validators and the like, to be connected to the gaming machine. The peripheral devices allow players to insert tickets and/or currency, which may represent credits to be downloaded onto credit meters on the gaming machine 52. As shown, the SMIB 52B may communicate with external slot accounting, ticket in ticket out (TITO) and/or player account management systems 51 over a casino network 53. In one aspect of the present invention, the service device 12 may emulate, to the gaming machine 52, a bill validator or ticket reader (not shown) for the purposes of the present invention (see below). The service device 12 may communicate to the SMIB 52B using a standard communications protocol. For instance, if the service device 12 is configured to emulate a ticket reader, the service device 12 communicates with the SMIB 52B using the slot accounting system or SAS protocol. Alternatively, if the service device 12 is emulating a bill validator, the service device 12 may plug directly into a bill validator or BV port on the SMIB 52B.

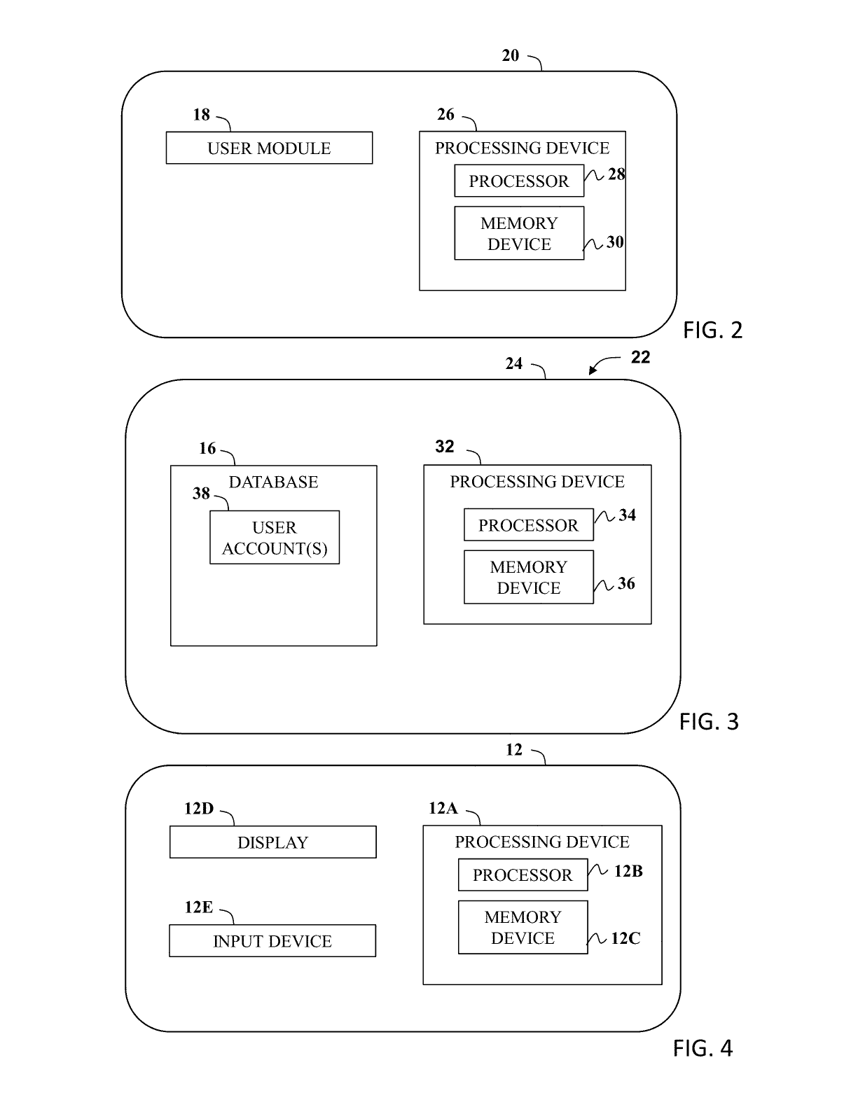

As shown in FIG. 4, an exemplary service device 12 according to an embodiment of the present invention, may include a processing device 12A, that includes a processor 12B and a memory device 12C. The service 12 may include a display 12D and an input device 12E. The input device 12E may include one or more physical buttons and/or a touchscreen device (not shown).

In another example, the gaming machine 52 may be a kiosk, mobile computing device, vending machine or point of sale device at which credits may be exchanged for product(s) and/or service(s). The service display 12 may also be a purchase gateway or display device.

As explained in more detail below, the user module 18 may be configured to control a processor of the user device 20 to allow a user to establish a player or user account. The player account includes a funding method and a payment method.

In general, the operation of the system involves the following processes (1) establishing/creating account, (2) funding the account, (3) creating a payment method, i.e., purchasing credits and (4) opening and closing game or gaming sessions.

First, a player account is created on the server system 22. The player account may be created by the player via an app on a mobile device, such as a cell phone or tablet, online via the mobile device, a kiosk or by an attendant or cashier.

The funding method or process allows the player to link the player account to one or more sources of funds, e.g., credit or debit card; bank account; EFT, etc. . . . The funding method also allows the player to transfer funds from one of these sources to the account. The funding method or process could be done remotely, i.e., through a computing device such as a personal computer, cell phone, tablet or other mobile device or at the gaming environment 14 at a kiosk or performed by an attendant or cashier.

The payment method or process allows the player to purchase credits using funds that were transferred into the account using the funding method. In one embodiment, credits may be purchased at any time, i.e., prior to the use thereof, or the opening of a gaming session. Any purchased credits are available at a gaming machine 52 during a gaming session. In another embodiment, credits are purchased when a gaming session is opened. The purchased credits are then available for use at a gaming machine 52 during the gaming session.

In one aspect of the present invention, only one gaming session could be opened per player at any one time. A player account could have one or more affiliated persons for whom a concurrent gaming session could be opened.

In another aspect of the present invention, more than one gaming session could be opened per player account. At the initiation of each gaming session, credits are purchased with some (or all) of the funds in the player account. At the initiation of a gaming session, the player may specify either (1) an amount of funds to convert to or use to purchase, credits or (2) a number of credits to be purchased using the available funds. Once a gaming session is opened and credits made available to, or associated with, the gaming session, the funds used to purchase the credits are locked. In other words, the funds used to purchase credits for an open gaming session are not available to purchase credits in other gaming sessions.

In one embodiment of the present invention, the opening of a gaming session on a gaming machine 52 during which credits may be used to purchase goods or services or make a wager is a multi-step process. As discussed above, a gaming machine 52 may be a mobile device, such as a cell phone. In one embodiment, the player may first request, i.e., initiate or open, a game session on their cell phone (as a game machine 52). A game session on the player's cell phone may be referred to as a “lobby”. Once such a game session or lobby is opened, the player may then open one or more second gaming sessions on one or more other game machines 52. At the initiation of each second gaming session, the player indicates a number of credits to be transferred or made available for use during the second gaming session. In one aspect of the present invention, the player may be allowed to purchase additional credits from funds available in the player account.

In practice, the player opens a primary game session on their cell phone and purchases credits that are then made available to one or more second game sessions on other gaming machines 52. It should be noted that once credits are made available in a second game session, the same credits are marked or flagged as unavailable for other second game sessions.

The player may close the second game session(s) at the respective gaming machines 52. When a second game session is closed, the credits remaining in the closed second game session are returned, i.e., made available in the primary game session or lobby on the player's cell phone.

The player may close all of the second game session(s) by closing the primary game session or lobby on their cell phone. When the primary game session is closed, any remaining credits in the second game session(s) are transferred back, or made available to the primary game session or lobby and then transferred back to the player account. In one embodiment, the player account may separately store funds and/or credits. In another embodiment, the player account only includes funds and any credits returned to the player account are first converted back into funds.

In one embodiment, when the player desires to access a specific gaming machine 52, the player may send a request to open a gaming session to the server system 22 using the user module 18 operating on their device 20. The user module 18 sends the request to the server system 22. In response, the server system 22 sends an access code to the user module 18. The access code may be in the form of a PIN or alphanumeric code that is displayed on the player's device 20. To open a gaming session on the gaming machine 22, the player enters the access code on the service device 12 associated with the gaming machine 22 the player wants to access. The access code is then sent to the server system 22 for confirmation. Once confirmed at the server system 22, the gaming session is opened, and the player may access their player account stored in the database and download credits to the gaming machine 12 using the service device 12 on the gaming machine. In one embodiment, the player must enter a gaming machine identification number associated with the specific machine 52 the player wants to use. The gaming machine identification number is sent to the server system 22 along with the request.

In an alternative embodiment, the player may request an access code at a kiosk (not shown). The kiosk may provide a ticket with the access code printed thereon. The access code along with a player identification number or PIN must be entered on the service device 12 in order to request a gaming session.

In a further alternative embodiment, the access code may be entered or sent to the service device 12 using RFID technology, near-field communications or other wireless communications. The access code may also be displayed on the player's device 20, e.g., in the form of a barcode, QR code or other machine-readable code, and read by a suitable reader at the service device 12.

In one embodiment, the funding method includes the creation of an electronic wallet. The funding method/electronic wallet may be maintained in a separate server 24.

The payment method allows the user to transfer funds into the electronic wallet. One or more payments may be established or associated with the electronic wallet. Possible payments include, without limitation, automated clearing house (ACH) transactions, debit or credit card transactions, payments made using virtual instruments, such as bit coins, and/or any other suitable methods.

With particular reference to FIG. 2, in one embodiment the user device 20 may include a processing device 26. The processing device 26 includes one or more processors 28, e.g., microprocessor, and memory 30. The memory 30 may include one or more different forms of forms of memory, static and/or dynamic, and configured to store programs, media and/or data.

The server system 22 is configured to be coupled to the user module 18 and to the database 16 and configured to control a server processor. In general, the user may be required to logon to the system 10 through the application or app or through a portal running on the world-wide web. The mobile device 20 may be coupled to the server system 19 via a wireless network 18 shown as a cellular network, a Wi-Fi network, of a near-field communications (NFC) network.

In general, the server system 22 may be configured to perform certain actions in response to the user module 18, e.g., commands or requests entered by the user on the user module 18. In one embodiment, the server system 22 may be configured to store the user account including the funding method and the payment method in the database 16.

The server system 22 may include one or more servers 24. With particular reference to FIG. 3, in one embodiment each server 24 may include a server processing device 32. The server processing device 32 includes one or more server processors 34, e.g., one or more microprocessors, and memory 34. The memory 34 may include one or more different forms of forms of memory, static and/or dynamic, and configured to store programs, media and/or data.

As stated above, the database 16 may reside and/or be implemented by one or more or the servers 24.

Once the user account has been created and stored in the database 16, the user module 18 may be further configured to control the processor to allow the user to transfer monetary funds into the user account using the payment method and to allow the user to purchase credits using the monetary funds.

In general, the environment 14 may require that purchases or wagers be made in credits. The conversion ratio between currency value and credits may be fixed or variable and may be set by an employee or agent associated with the environment 14.

The service device 12 may be coupled to the database 16 and, as discussed above, may be configured to provide service(s) and/or good(s) in exchange for a predetermined number of credits.

The user module 18 may be further configured to control the processor to allow the user to request an ancillary account, e.g., a temporary or child account with an associated number of credits. The server system 22 may be further configured to control the server processor to create the temporary account with the associated number of credits and to generate a temporary account code. The service device 12 may be further configured to accept the temporary account code, to open a gaming session and to transfer the credits associated with the temporary account from the database 16 to the service device 12 and to responsively provide the good(s) and/or service(s). Once the gaming session has been closed or the temporary ancillary account used, the ancillary account may be deleted.

In one aspect of the present invention, the system 10 may be used with a gaming system 50 to allow a player to utilize funds that are deposited within a player account. An exemplary system 10 is shown in FIGS. 1-4. The gaming system 50 includes a plurality of gaming machines 52. The system 10 includes a database 16, a player or user module 18, a server system 22 and a service device 12. The player account is stored in the database 16. The player module 18 is associated with a mobile device 20. The server system 22 is coupled to the database 16 and the user module 18. The service device 12 is coupled to the database 16 and the server system 22 and is located at, and coupled to, a respective gaming machine 52. The player module 18 is configured to allow the player to logon and access the player account on the server system 22 and to allow the player to request a first gaming session. The server system 22 is responsively configured to open the first gaming session on the server system 22, to convert at least a portion of the funds in the player account to credits, and to associate the credits to the first gaming session. The player module 18 is further configured to allow the player to request a second gaming session associated the gaming machine, and to authenticate the request for a second gaming associated using the service device 12 and the player module 18. The server system 22, in response to the request being authenticated, is further configured to open the second gaming session, to associate at least a portion of the credits associated with the first gaming session to the second gaming session, and to transfer the credits transferred to the second gaming session to the gaming machine 52 using the service device. The player may purchase service(s) and/or good(s) in exchange for a predetermined number of credits during the gaming session. The service device 12 is further configured to close the first and second gaming sessions on the server system and to transfer any remaining credits on the gaming machine to the server system at the close of the gaming session.

In embodiment, of the present invention, the server system 22 prevents opening of a secondary second gaming session on the server system 22 for the player while the first gaming session is open. This prevents the same funds from being used or accessed more than once.

In an alternative embodiment, the server system 22 allows opening of a secondary second gaming session on the server system. However, the funds used to purchase, or converted into, credits and associated with the first gaming session are locked on the server system 22. Further, the credits in the first gaming session that are transferred for use in the (primary) second gaming session are locked within the first gaming session and may not be used or transferred to a secondary gaming session.

In one embodiment, the player module initiates the first or primary gaming session using the player or user module 18 on their mobile device 20. As discussed above, the player may specify or indicate either the amount of funds from their player account stored in the database 16 to be converted into credits or the number of credits to be purchaser. The purchased credits are transferred to the first gaming session or lobby within the user module 18. In the illustrated embodiment, the funds user to purchase credits remain within the player account, however, the used funds are locked such that the used funds cannot be utilized by another gaming session. After the first gaming session or lobby has been created, the user module 18 is further configured to allow the player to request initiation of a second gaming session on a gaming machine 52.

The user module 18 sends the request to open the second gaming session to the server system 22. The request may be sent over a cellular network, wireless or Wi-Fi network or other wireless network. In response to receiving the request, the server system 22 is configured to generate an access code. The access code is sent back to the user module 18 where it may be displayed.

In order to utilize the code on a specific gaming machine 52, the player approaches the gaming machine 52. The associated service device 12 may provide a button or input that allows the player to enter an access code. After the player actuates the button or input, the access code may be entered directly into or onto the service device 12. In response to receiving the access code, the service device 12 sends a request authorization message back to the server system 22.

In response to receiving the request authorization message, the server system 22 authenticates the access code and sends an authorization signal back to the service device 12 at the gaming machine 52. Then the service device 12 may open the second gaming session.

In one embodiment, in order to authenticate the access code, the server system 22 may send a may send a confirmation request to the user module 18. In one embodiment, the confirmation request may include a plurality of images. One of the images may also be displayed on the service device 12. The player is asked to confirm that the player desires to open a secondary gaming machine on the gaming machine 52 associated with the service device on which the image is being displayed. In order to confirm, that the player desires that a secondary gaming session be opened on that service device 12, the player selects on the player or user module 18, the image currently being displayed on the service device 12. The selected image is sent back to the server system 22. If the selected image matches the image being displayed on the service device 12, then the request may be authorized.

In a further aspect of the present invention, based on an outcome of a game played on the gaming machine 52, the player may be awarded an award. In some jurisdictions, an award over a predetermined threshold must be reported to a governmental agency. Upon detection of an occurrence of a taxable event, associated taxable credits, e.g., the amount of an award of the predetermined threshold may be removed from the first and second gaming sessions. The taxable credits may be converted to funds and then stored in the player account in the database. These funds may be locked, i.e., unavailable, until the required reporting has been performed. It should be noted that any remaining credits in the first and/or second gaming session may be continued to be used.

With reference to FIGS. 4-7, the system 10 may be utilized by a user to create a funding method, which may be referred to as an “electronic wallet” or “e-wallet”, transfer funds into the e-wallet. The user may further utilize the funds in the e-wallet to purchase credits for use at one or more service device(s) 12.

With particular reference to FIG. 4, a method 40 for operating a system, such as the system 10 discussed above, is shown. In a first step 40A, the player may establish a player account. The player account may be stored in the database 16. In a second step 40B, the player may fund the account by transferring funds into the player account and to purchase credits for use in the gaming system using the funds transferred into the player account. The transferred funds and the purchased credits may be stored in the player account. The player may access the player account and initiate a gaming session on the server system 22, using a service device 12 associated with a desired gaming device 52 in a third step 40C. In a fourth step 40D, the player may download credits from the player account stored in the database to purchase service(s) and/or good(s) in exchange for a predetermined number of credits during the gaming session. The gaming session is closed in a fifth step 40E and remaining credits on the gaming machine are transferred to the server system 22. The remaining credits are then stored in the player account in the database 16 in a sixth step 40F.

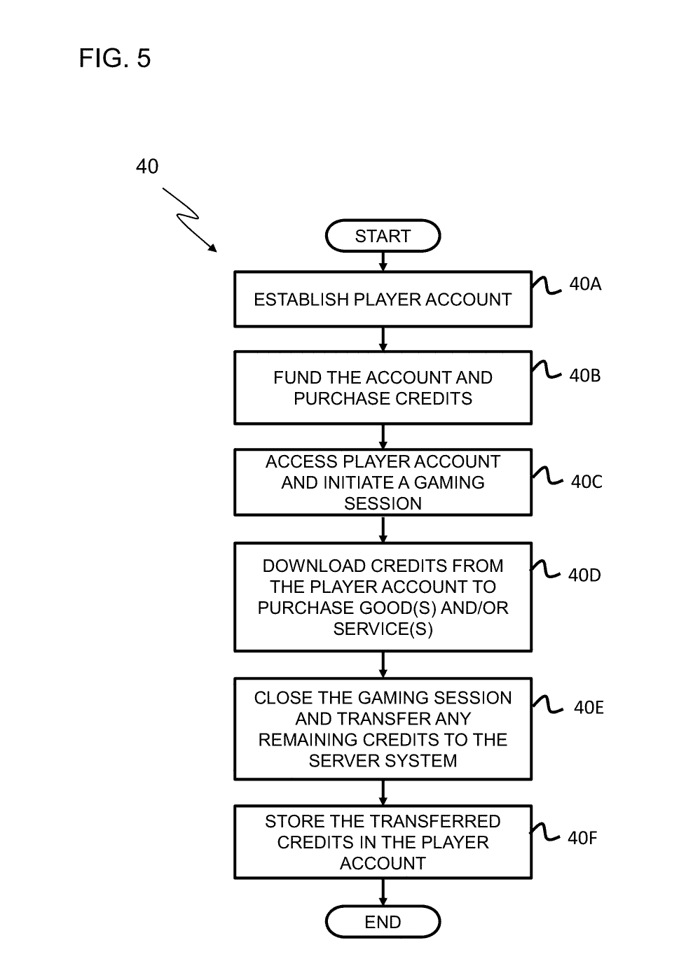

With particular reference to FIG. 5, a method 50 for allowing a user to enroll in a service that allows the user to create and transfer funds into an e-wallet and utilize the transferred funds to purchase credits is shown.

It should be noted that a service device 12 may be any approved gateway that allows credits to be exchanged for service(s) and/or good(s).

In a first step 50A, the user downloads an app to their user device 20 or accesses a web portal through a web enabled user device 20. In a second step 50B, the user is allowed to create a user account by entering required information, e.g., name, address, and creating a user name and password/PIN. The user name and password/PIN may be required to logon onto the system 10. It should be noted that other methods may be used to logon onto the system 10, including, but not limited to biometrics.

In a third step 50C, the identity of the user is verified and the funding method or e-wallet is created. In a fourth step 50D, the user establishes a payment method. The payment method allows the user to transfer monetary funds from an external account to the payment method. Once the funding method includes funds, the funds may be used to purchase credits (see above).

The user details, the funding method and the payment method are part of the user account. Once the user details, funding method and payment method have been established, the user account may be stored in the database 16. It discussed above, more than one payment method may be established. The player may be provided an option to choose one of the established payment methods from which to transfer monetary funds to the funding method or e-wallet. In use, all usage of the user account, including the transfer of funds to the e-wallet and/or the purchase of credits using the transferred funds and/or usage of the credits to purchase service(s) and/or good(s) and/or the redemption by the player of credits are tied to, i.e., saved into the user account in the database 16.

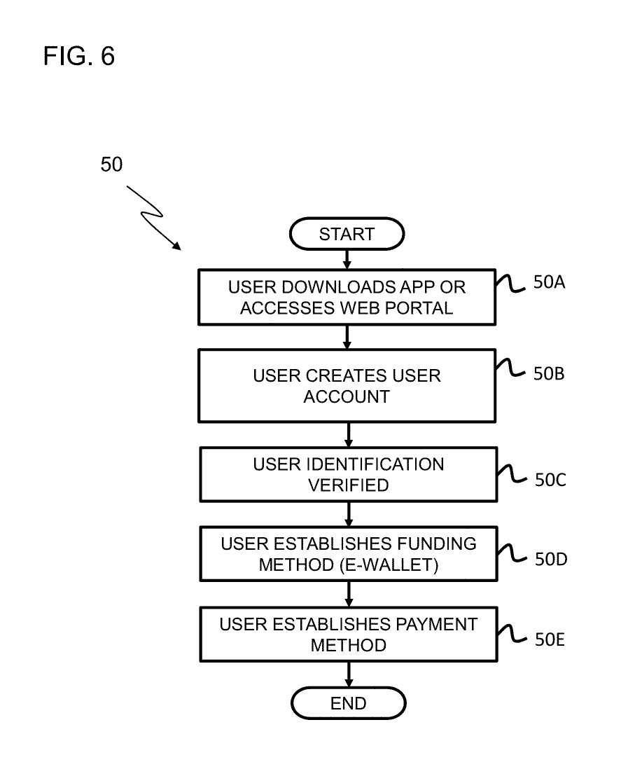

With particular reference to FIG. 6, once the user account has been established and saved in the database 16, the user may transfer monetary funds into the e-wallet using the payment method and then purchase credits.

In a first step 52A, the user accesses their user account through the app on their user device 20 or through the web portal. In a second step 52B, the user adds monetary funds to the e-wallet using the payment method (or a selected one of the payment methods). In a third step 52C, a confirmation notification regarding the transaction is sent to the user. In general, the notification may be sent via a preferred method which may be established and/or change by the user in the user account. For example, the notification may be sent by email, text, push notification, and/or message within the app or web portal.

In a fourth step 52D, the user may establish a number of credits to purchase by entering the number of credits directly, or alternatively, by entering a monetary value to be converted to credits.

In one embodiment, the funding method is maintained or implemented by a server 24, or user account server, that is separate than the server, or e-wallet server, which maintains and manages the database 16. In a fifth step 52E, the user account server 24 connects to the e-wallet server 24 to confirm user account in a sixth step 52F. The balance within e-wallet is checked to confirm that there are adequate funds to cover the transaction in a seventh step 58H. If the e-wallet contains sufficient funds, then, in an eighth step 58I, the transaction or purchase of credits is approved. In a ninth step 521, a confirmation notification regarding the transaction is sent to the user. In general, the notification may be sent via the preferred method (see above).

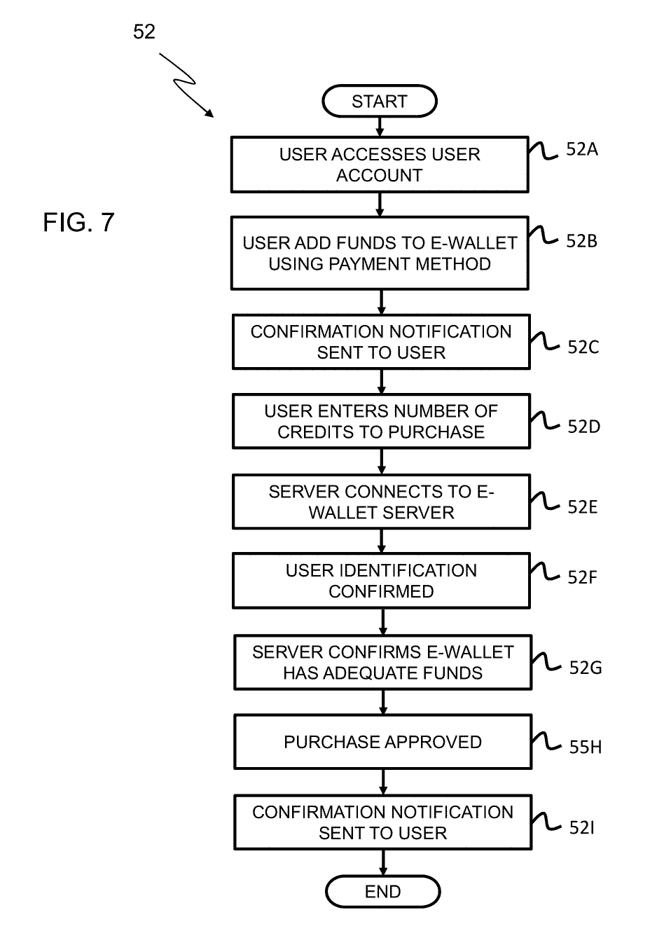

Once monetary funds have been transferred to the e-wallet and credits purchased, the user utilize the credits to purchase service(s) and/or good(s) at a service device 12. With particular reference to FIG. 7, a method 56 that allows a user to purchase service(s) and/or good(s) at a service device 12 is provided. In a first step 54A, the user logs onto the system 10 and requests a PIN or ticket to be generated. The pin or ticket is the funding method the user account has been established and saved in the database 16, the user may transfer monetary funds into the e-wallet using the payment method and then purchase credits. In one embodiment, the payment method is maintained or implemented by a separate server or servers 24, or payment method server (s). In a second step 54B, the user account server 24 communicates with the payment method server to create the PIN or ticket. In one embodiment, the server(s) 24 create a child or temporary account that is linked to the PIN or ticket. In a third step 54C, the PIN or ticket is displayed on the user device 20.

Once the user has the PIN or ticket, the user may utilize the PIN or ticket to make a purchase at a service device 12. If a PIN is used, the user may enter the PIN directly into a (physical or virtual) keypad at the service device 12. A ticket may be a virtual ticket that includes a bar code or a physical ticket with a bar code. The ticket may be scanned, i.e., by a reader, for example, a bar code reader, on the service device 12. In a fourth step 54D, the user may enter the PIN or scan the ticket at the service device 12. The purchase is completed in a fifth step 54E. The purchase is are recorded in the user account in the database 16. In a sixth step 54F, a confirmation notification regarding the transaction is sent to the user. In general, the notification may be sent via the preferred method (see above).

It should be noted that the purchased service may be game play at the service device 12. Once the PIN has been entered or the ticket scanned, a gaming session may be initiated at the service device 12. Details regarding the user's play during the gaming session may also be stored in the user account.

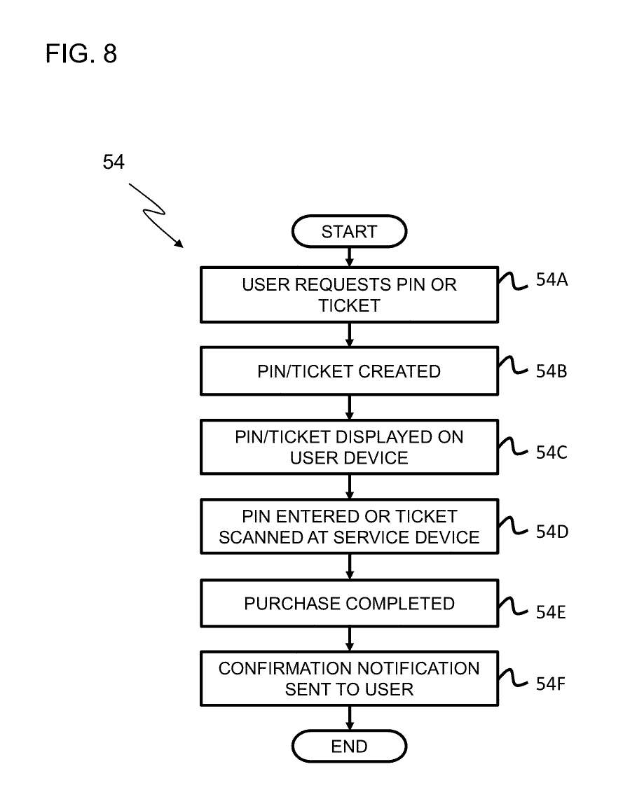

The user may desire to redeem credits and transfer the resulting funds into the e-wallet. A method 56 that allows the user to redeem credits is shown in FIG. 8. In a first step 56A, the user may end a gaming session or complete transaction and requests that the remaining credits be redeemed. In a second step 56B, the child or temporary account is delinked from the PIN or ticket. All credits are transferred back to the user account. In a third step 56C, the user requests that credits be redeemed, e.g., by requesting a “cash out” on the app or web portal on the user device 20. In a fourth step 56D, the user establishes or enters a number of credits to be redeemed. In a fifth step 56E, the established number of credits are converted to money and transferred to the funding method, i.e., e-wallet.

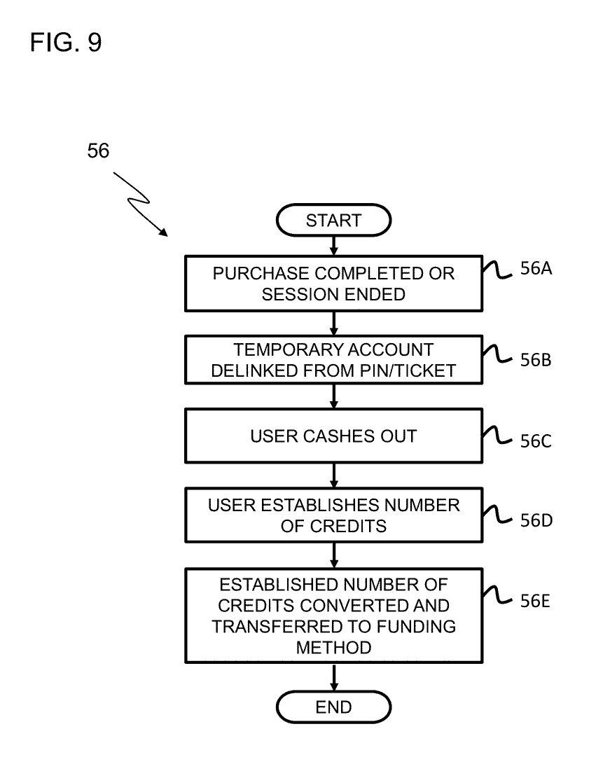

With reference to FIGS. 9-11, the system 10 may also be utilized by a user that does not have an account, an anonymous user.

With reference to FIG. 9, a method 58 allows the anonymous user may purchase credits using cash. In a first step 58A, the anonymous user deposits cash at a kiosk or with a cashier. The cash is deposited into an e-wallet (step 58B) and temporary user account is created (58C). In a fourth step 58D, a PIN or ticket is created. The PIN or ticket may be sent to the player electronically or a slip of paper may be provided on which the PIN or ticket is provided and presented to the user (Step 58E).

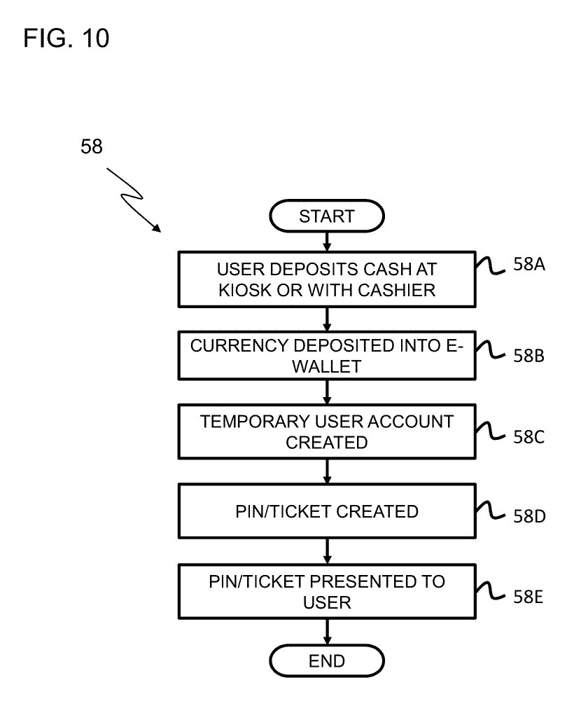

With reference to FIG. 10, a method 60 that allows the anonymous user to utilize the PIN/ticket at a service device 12 is shown. In a first step 60A, the anonymous user may enter the PIN or scan the ticket at the service device 12. The purchase is completed in a second step 60B. In a third step 60C, the purchase is recorded in the temporary user account in the database 16. In a fourth step 60D, a confirmation notification regarding the transaction is sent to the user. In general, the notification may be sent via the preferred method (see above).

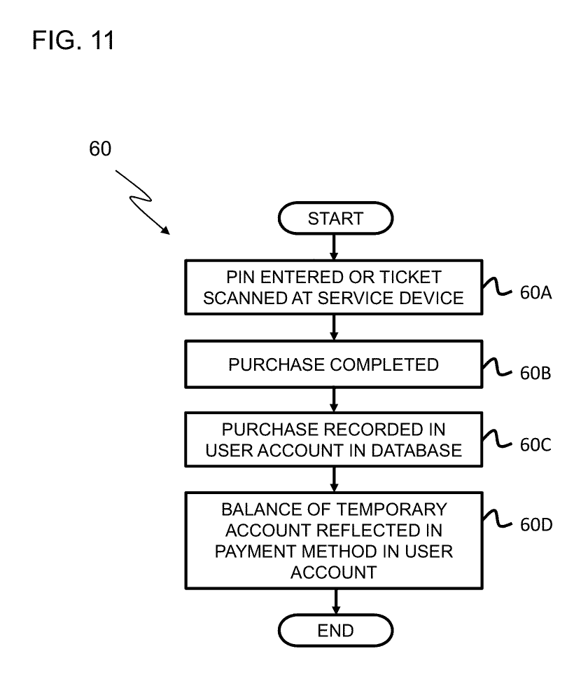

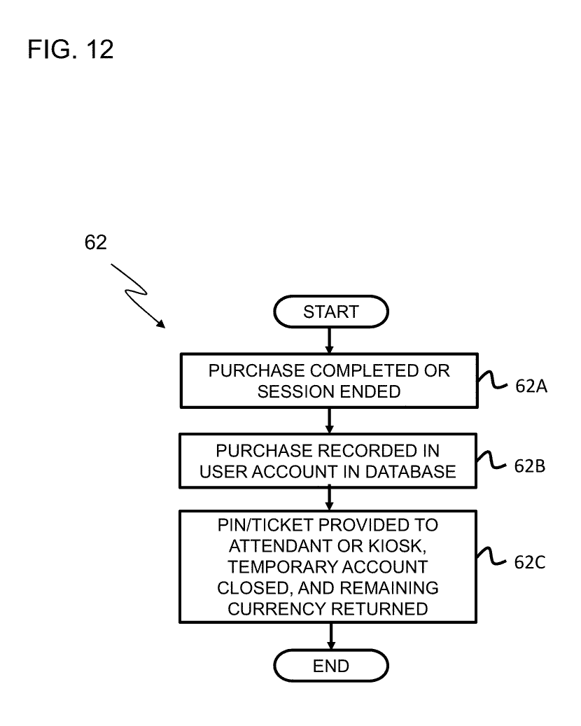

With reference to FIG. 11, a method 62 that allows the anonymous user to redeem credits is shown. In a first step 62A, the user may end a gaming session or complete transaction and requests that the remaining credits associated with the PIN/ticket be redeemed. In a second step 62, the purchase is recorded in the temporary account linked to the PIN/ticket. In a third step 62C, the PIN/ticket is provided to an attendant or inserted into a kiosk. The temporary account is closed and all remaining currency or cash is returned to the user.

In another aspect of the present invention, the server system 22 may include one or more game servers 24. Once a gaming session has been opened, the player may be provided access to a plurality of games stored on one of the servers 24 of the gaming system 22. In general, the games provided by the game server(s) may be downloadable games and/or streamed games. In addition, one or more game(s) may be run on the server and/or on the gaming machine 52. For example, a game may be run within a web browser running on one of the gaming machines 54. The games provided by the game server(s) 24 may be game of chance or at least partly skill-based games. Furthermore, access to other types of games or wagering opportunities, e.g., access to a sports book and/or off-track betting resources, may also be provided by the game server(s). As discussed above, the game session is opened on the server system 22 and may be accessible by the player via the user module 18 and the service device 12. Generally, although each player account may have associated ancillary accounts, only one gaming session may be open for a player. The ancillary accounts are generally assigned to associated other person(s). An ancillary gaming session associated with an ancillary account may be opened at the same time as a gaming session for the primary account.

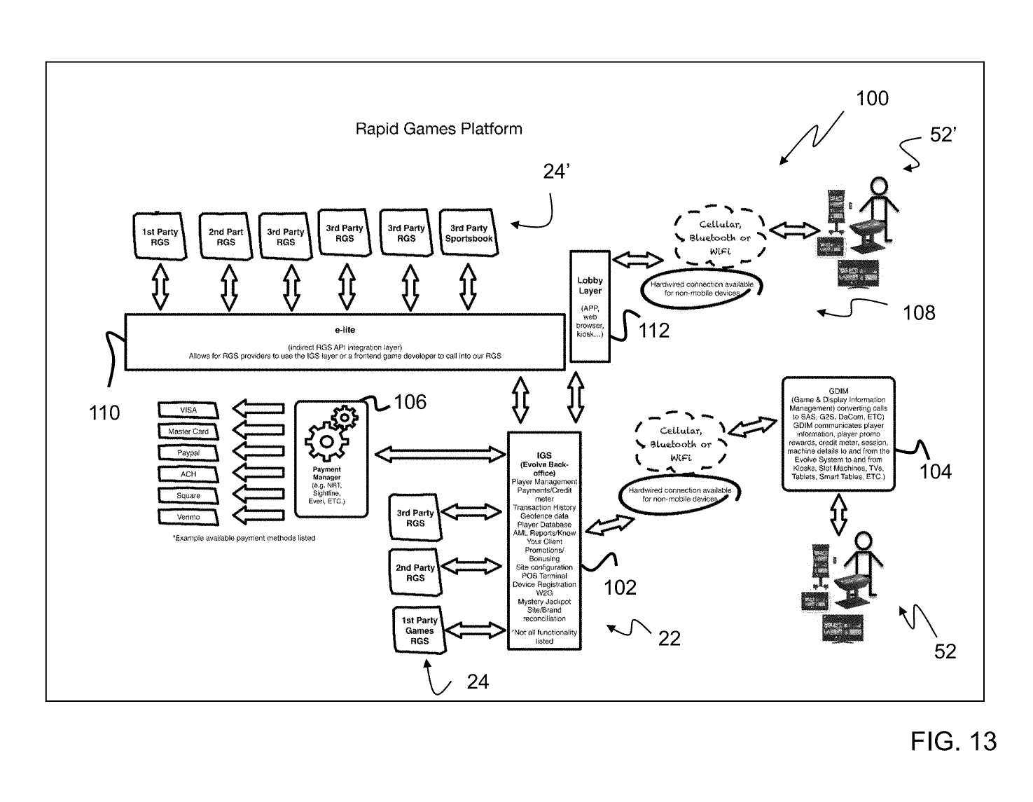

With reference to FIG. 13, an exemplary system 100, which may be referred to as the “Rapid Games Platform” or RG Platform 100 is shown. The RG Platform 100 may be provided, e.g., in the lobby or primary game session opened on the player's cell phone, tablet or other computing device. In the exemplary embodiment, the system 100 includes a server system 22 that allows users or players to manage all functions of the system 100. The server system 22 implements a backend module 102 configured to communicating with the service devices 12 (not shown in FIG. 13) located with the gaming machines 52′ and/or with the gaming machines 52′ directly. In the exemplary system 100, a gaming machine 52′ may be a kiosk, a stand-along gaming device, such as a video slot machines, a television set or other display device, computing devices, such as personal computers, tablets, or mobile devices, smart tables, or the like. The gaming machine 52′ or service device 12 implements a game & display information management module 104 implements the functionality provided by the system 100 to the player. The gaming machines 52′ and/or service devices 12 may communicate with the backend module 102 at the server system 22 over a wireless communications channel implemented using cellular, Bluetooth, Wi-Fi or other suitable communications protocol. Alternatively, for non-mobile gaming machines and/or service devices a hardwire communications channel, such as a local area network may be used.

A payment manager 106 manages the funding and payment functions. In the illustrated embodiment, a player may establish one or more funding sources, including but not limited to debit or credit card(s), PayPal, ACH, Square, Venmo, ACH transactions, payments made using virtual instruments, such as bit coins, and/or any other suitable methods.

As shown, one or more game server(s) 24 may be coupled directly to the backend module 22. Each game server 24 may be associated with one or more other parties, e.g., 1^{st}, 2^{nd}, or 3^{rd} parties. Each game server 24 may provide access to games contained in a game library associated with the associated other party. One or more game server(s) 24 may provide access to a sports book to allow wagers to be placed on one or more sporting event(s).

The system 100 may also include a subsystem that provides games (or access to games) through an application running on a gaming machine 52′. For instance, each gaming machine 52′ may be capable of running or providing games, including access to a sports book function. In the subsystem 108, external parties may be provided access to the system to indirectly provide game(s) using servers 24′. The external party or parties access the system 10 through an API integration layer 110 that allows the external party servers to call into the server system 22. The games are provided to the gaming machines 52′ through a layer module 112. The layer module 112 communicates with the gaming machines 52′ or service devices over a wireless communications channel implemented using cellular, Bluetooth, Wi-Fi or other suitable communications protocol. Alternatively, for non-mobile gaming machines 52′ and/or service devices a hardwire communications channel, such as a local area network may be used.

### INDUSTRIAL APPLICABILITY

With reference to the drawings and operation, the present invention presents a system, method and computer product configured to allow a user to fund and utilize a financial account to purchase services and/or goods on a service device. In one non-limiting application of the present invention, the system, method and computer product may be utilized in a casino gaming environment. One type of service device 12 included in the system 10 may include table games. The table games may include an electronic interface to a table game controller that may control aspects of the game, including wagers and table player accounts. The table game controller may be assessable via a tablet or other computing device.

The service devices 12 available in the gaming environment are configurable by the operator of the gaming environment. The system 10, for example, may include a solution that allows the user to create and fund the e-wallet and purchase credits using funds in the e-wallet from an app or via a web portal on a user device. As discussed above, the system may also include a solution that allows an anonymous user to deposit cash at a kiosk or at a cashier and create a temporary account. The system may be fully customizable and/or configurable.

The system 10 allows two types of players to utilize the service devices 12: (1) a user that has an account and has added funds to their e-wallets using via the app or web portal and (2) a user without an account, i.e., an anonymous user who purchases credits though the system using cash.

With respect to anonymous users, in one embodiment the player provides cash to an attendant at the cage or to a kiosk and is provided a ticket, e.g., on thermal paper, that includes a 6 digit PIN. The PIN may have an expiration time/date. The expiration time/date may be configurable by the operator through the system 10. The system 10 may require a unique secondary identification number, such as a driver's license number in case the user loses the ticket.

In another aspect of the present invention, a PIN may be table specific. For example, if a particular table that the user may want to join has 4 seats, of which 2 are open, the user may request, through their mobile device, to be transferred or seated at the desired table. The system 10 may then generate a PIN which may be used at any available seat at that table.

In another aspect of the present invention, the player may add funds to the e-wallet, purchase credits and/or cash-out via the app, web portal or at the service device 12.

In still another aspect of the present invention, a player (known or anonymous) may request to be transferred to another gaming machine 52. The player may request the transfer using the user module 18 on their mobile device 20 or via the service device 12. In response to the transfer request, the current gaming session is closed and a new access code is generated. The new access code may be set, via, the server system 22 to the user module 18 or ticket printed by the gaming machine 52.

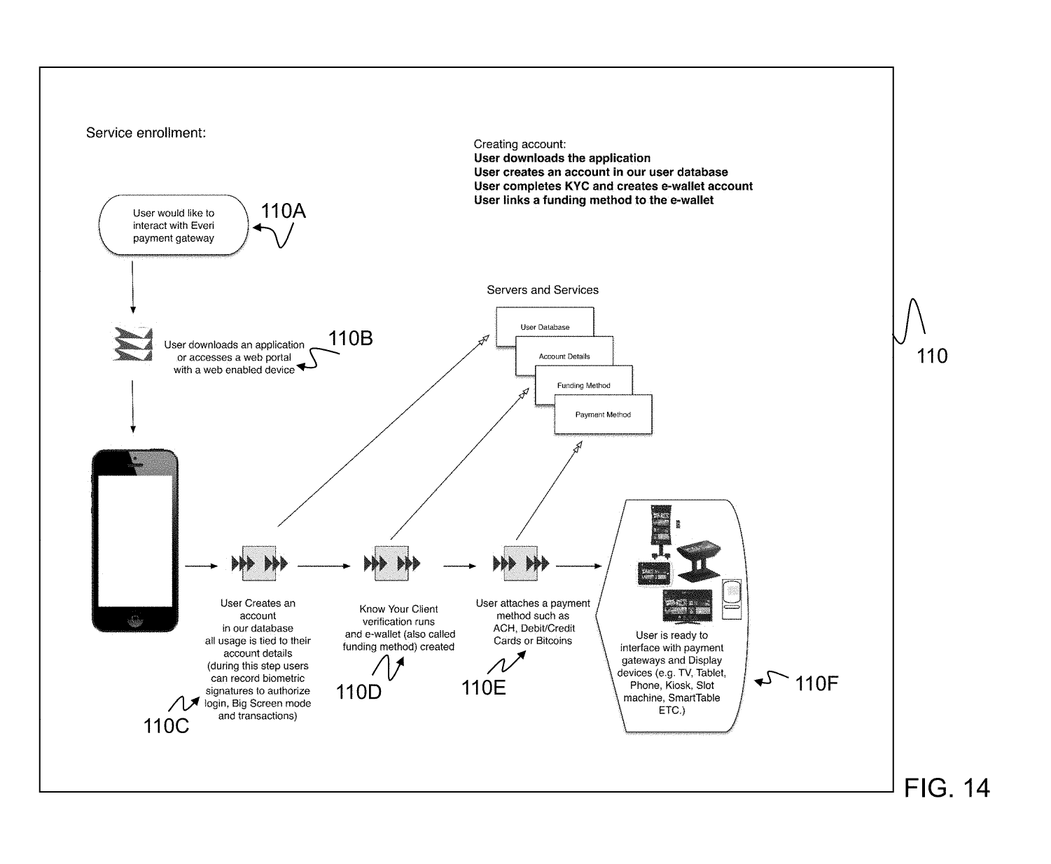

With reference to FIGS. 14-17, methods 110, 112, 114, 116, 118 shows operations of the system 10 with a known user or player, i.e., a player that is known and has an account in the system 10. With particular reference to FIG. 14, a process diagram of a service enrollment method 110 is shown. In the illustrated embodiment, the player may create an account and, using the funding process creates an electronic wallet or e-wallet using a mobile device such as a cellular telephone. Using the funding process, the player may link a funding source or method to the e-wallet to transfer funds thereto. In a first step 110A, the player initiates the process by accessing a payment gateway. In a second step 110B, the player downloads an application or app to their mobile device or accesses a web portal on a web enabled device, e.g., a personal computer, laptop computer, tablet or other suitable device. In a third step 110C, the user is prompted to complete the steps necessary to create an account in the database 16. All subsequent usage is tied to the account and may be recorded in the database 16. During the creation of the account, the player may record account access parameters, e.g., creation of a password, PIN or biometric signatures which are used to authorize login, Big Screen modes at suitable devices and transaction.

In a fourth step 110D, a verification client (known as “Know Your Client” or KYC) is run. After the verification has been performed, the e-wallet or funding method is created. The user or player may then attach one or more payment methods (see above) to the account (step 110E). After at least one payment method has been affiliated or assigned to the account, the player is ready to interface with payment gateways or to access their account via different gaming machines 52 and/or service devices 12.

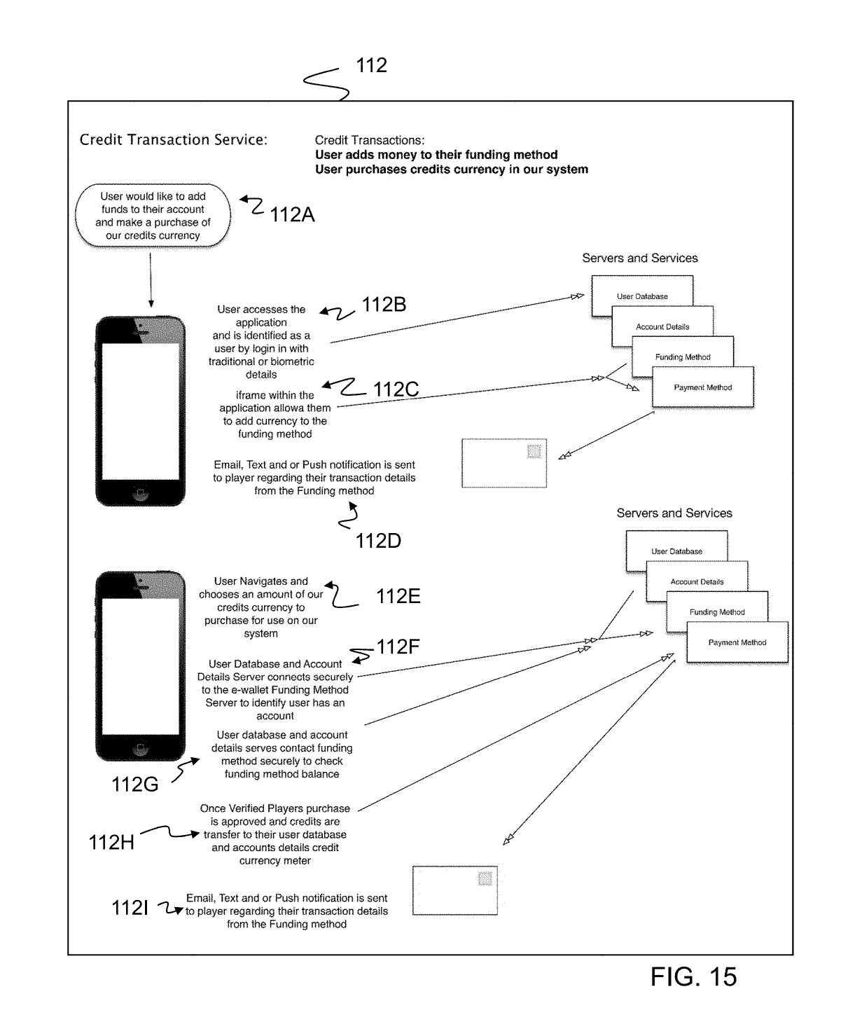

With reference to FIG. 15, a credit transaction process 112 is shown. The credit transaction process 112 allows the user or player to add funds to their account and/or to make a purchase of credits using funds in their account. In a first step 112A, the player initiates a credit transaction. In a second step 112B, the user or player access the application or app on their device or through the web portal. The player logs on by entering the password or PIN or by using their biometric signature. In a third step 112C, the app allows the player to add currency to the funding method, i.e., transfers funds to their e-wallet using one of the associated payment methods (see below). A confirmatory message with the transaction details is sent to the user or player using a suitable method defined in the user account, e.g., email, text or a push notification in a fourth step 112D. In a fifth step 112E, the user may navigate through the app to purchase credits using funds in the e-wallet. The user may select or enter either an amount of funds to convert to credits or a number of credits to purchase using funds in the e-wallet. In a sixth step 112F, the account server 24 communicates with the funding method server to confirm that the user or player has an account.

In a seventh step 112G, the account server 24 contacts the funding method to confirm the funding method balance, i.e., to confirm that the player's account contains adequate funds to cover the transaction. Once the purchase has been verified, the purchased credits are transferred to the database 16 and stored in the player account in an eighth step 112H. Then in a ninth step 112I, the player is sent a confirmatory message with the transaction details using a suitable method defined in the user account, e.g., email, text or a push notification.

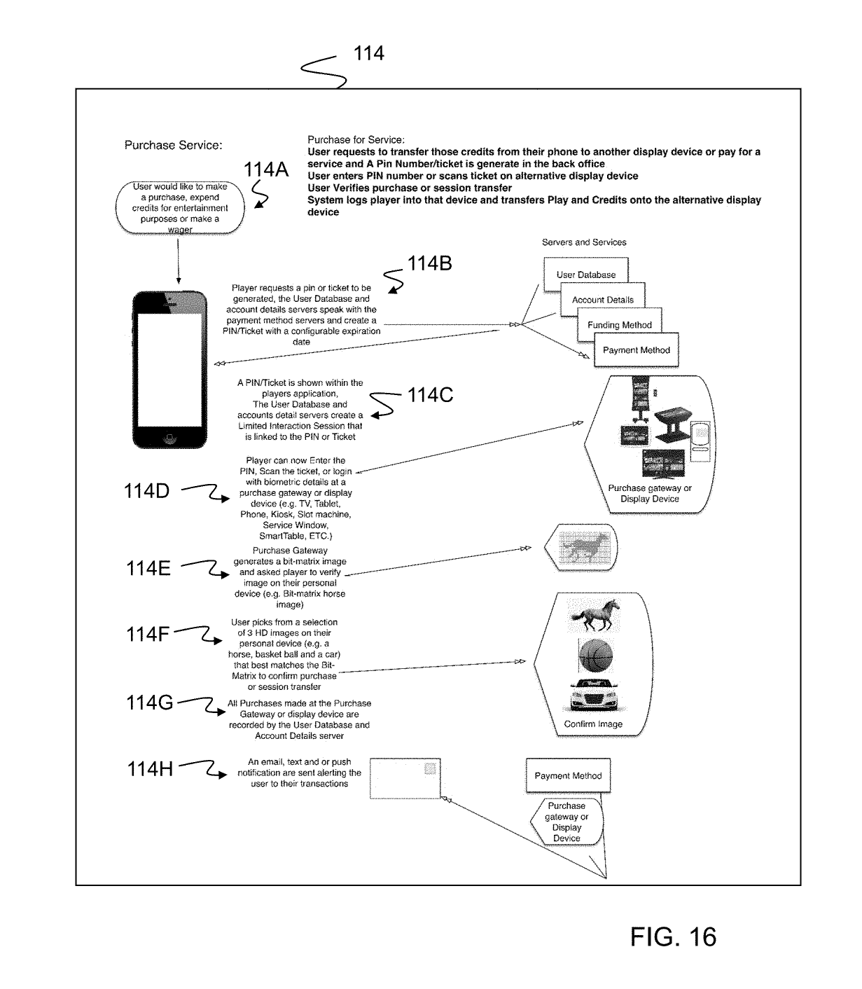

With reference to FIG. 16 an exemplary purchase service method 114 is shown. In the purchase service method 114, the user or player may request that a gaming session be opened on a gaming machine 52 or service device 12. Once the gaming session is open, the purchased credits may be transferred from the player's account to the credit meter on the gaming machine 52. In a first step 114A, the user or player initiates the purchase service method 114 by, for example, accessing the app on the mobile device, for the purpose of, e.g., make a purchase using credits, expends credits for entertainment or make a wager. In a second step 114B, the player requests a PIN or ticket to be generated. The user database and/or account server 22 communicates with a payment method server(s) 22 to create the PIN/ticket. The PIN/ticket may have an expiration date that is configurable by the property.

In a third step 114C, the PIN/ticket is displayed within the app on the player's mobile device and the gaming session is opened on the server 22. The player can enter the PIN or scan the ticket, or logon to the gaming machine 52 or the service device 12 using their biometric signature in a fourth step 114D. In a fifth step 114E, the purchase gateway server 22 generates an image that is displayed on the service device 12 or gaming machine 52, which then may be verified on the player's mobile device in a sixth step 114F.

In a seventh step 114G, all purchases (including wagers) are recorded in the player account in the database 16. Then in an eighth step 114H, the player is sent a confirmatory message with the transaction details using a suitable method defined in the user account, e.g., email, text or a push notification.

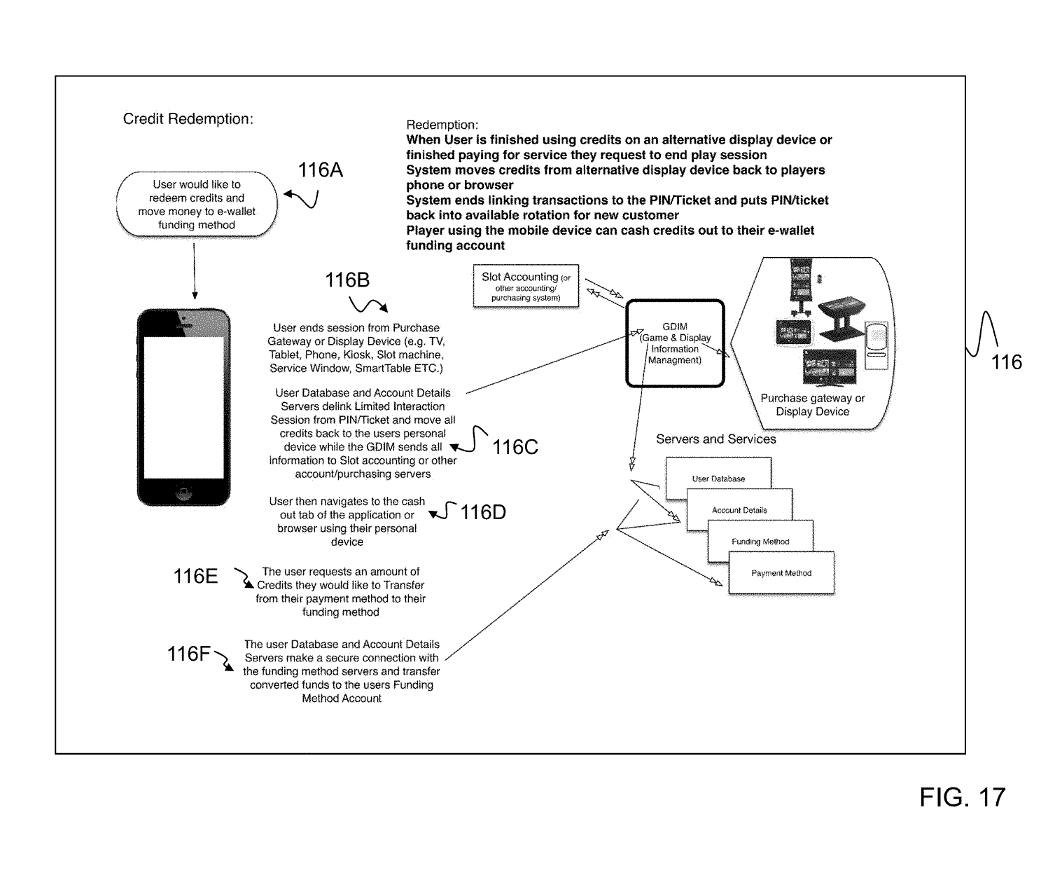

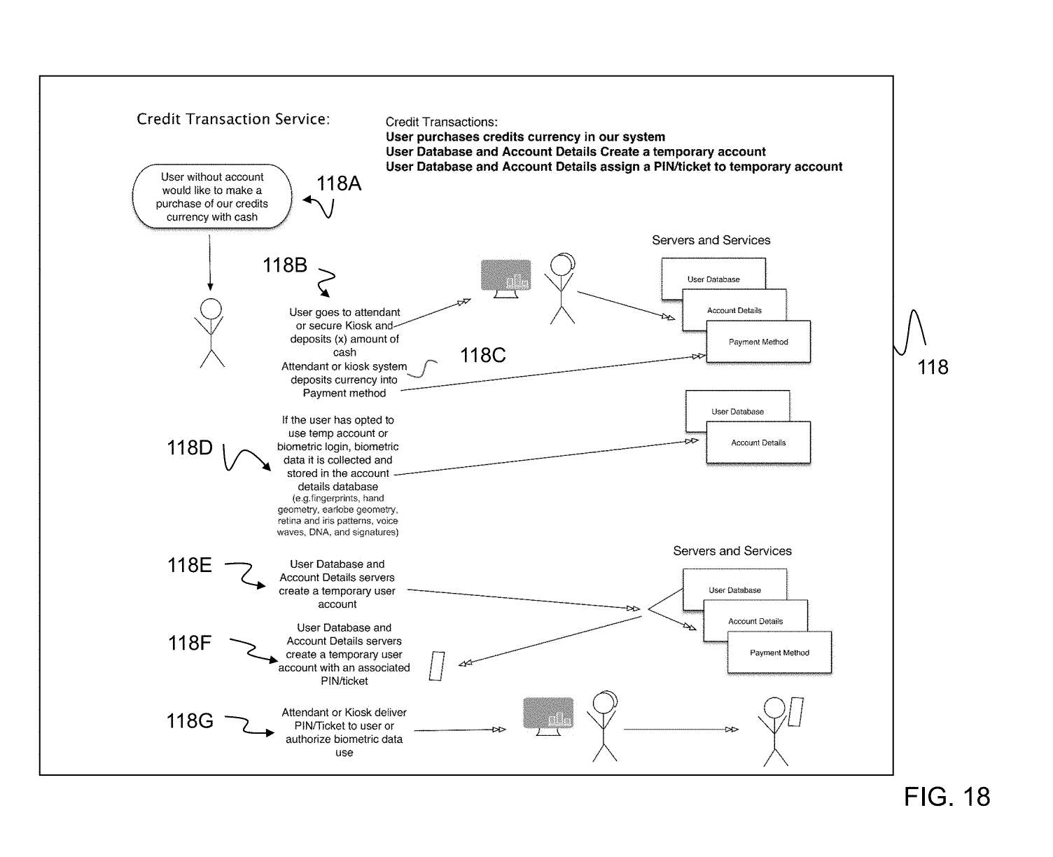

With reference to FIG. 17, a credit redemption method 116 allows a player to end a gaming session and to redeem credits any remaining credits stored on the credit meter on the game machine 52. In a first step 116A, the player desires to redeem credits by first transferring the credits from the credit meter to the player's mobile device and convert the credits back to currency to store in the e-wallet. In a second step 116B, the player ends the gaming session. In a third step 116C, the gaming session is delinked from the PIN or ticket and move all (remaining) credits from the credit meter to the mobile device of the player. The player may then “cash out” in the app running on their mobile device in a fourth step 116D. In a fifth step 116E, the player may enter an amount of credits to be converted to cash. The funds are then moved to the (selected funding method). Any remaining or non-converted credits are stored in the player account.

With reference to FIG. 18, a credit transaction process 118 for an anonymous player is shown. The credit transaction process 118 allows a user or player to purchase credits using currency or cash and to utilize the purchases credits in the system 10.

In a first step 118A, the player initiates a credit transaction. In a second step 118B, the user or player deposits currency or cash into the system 10 at a kiosk or with an attendant. The currency is deposited into the payment method in a third step 118C. The player may convert all or some of the deposited currency into credits. If the player opts to use a biometric signature, biometric data or signature are collected in a fourth step 118D. The server system 22 creates a temporary (user) account in a fifth step 118E. If the player desires to use a PIN, a temporary PIN is generated and provided to the player, e.g., on a printed ticket in a sixth step 118F. In a seventh step 118G, the PIN/ticket is delivered to the player or use of the biometric signature is authorized.

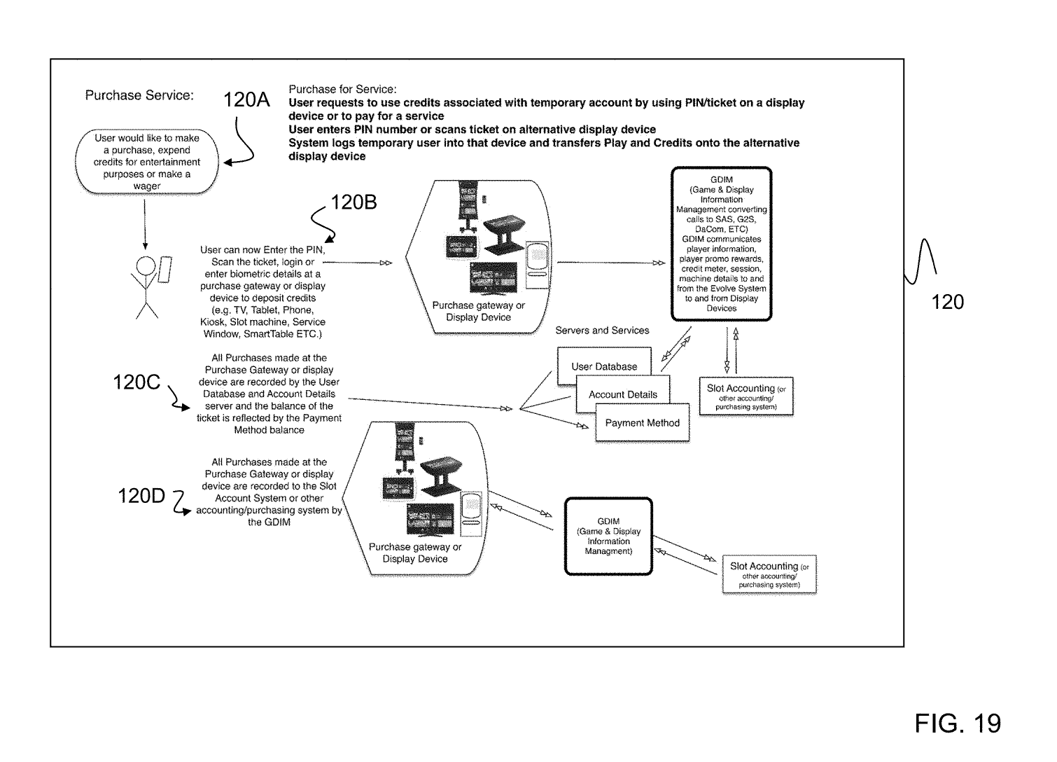

With reference to FIG. 19 an exemplary purchase service method 120 using the temporary account is shown. In the purchase service method 120, the user or player may request that a gaming session be opened on a gaming machine 52 or service device 12. Once the gaming session is open, credits associated with the temporary account may be used to pay for a service or goods, purchase entertainment and/or make a wager.

In a first step 120A, the user or player initiates the purchase service method 120 by for the purpose of, e.g., make a purchase using credits, expends credits for entertainment or make a wager. In a second step 120B, the player can enter the PIN or scan the ticket, or logon to the gaming machine 52 or the service device 12 using their biometric signature. In a third step 120C, all purchases (including wagers) are recorded in the player account in a slot accounting system or other account system.

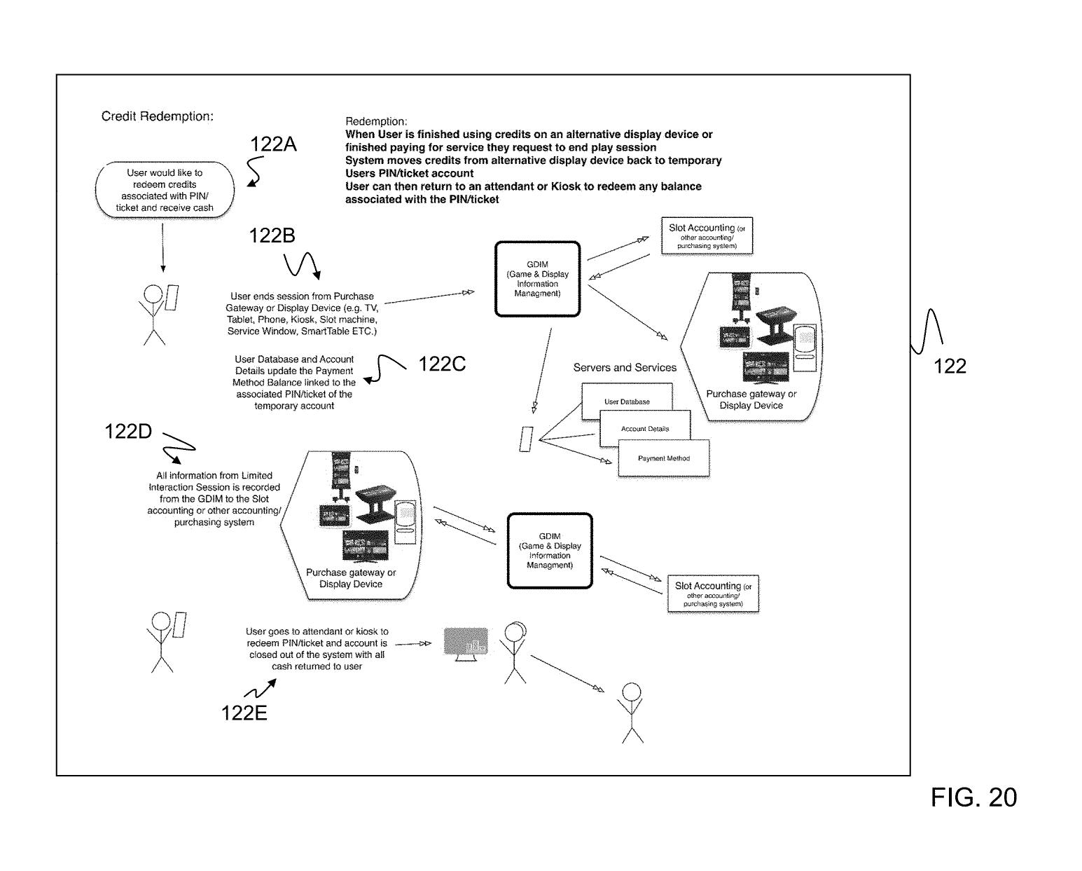

With reference to FIG. 20, a credit redemption method 122 allows a player to end a gaming session and to redeem credits any remaining credits stored on the credit meter on the game machine 52. In a first step 122A, the player desires to redeem credits by first transferring the credits from the credit meter to the temporary account and convert the credits back to currency. In a second step 122B, the player ends the gaming session. In a third step 122C, the gaming session is delinked from the PIN or ticket and the number of credits in the temporary account is updated. All information related to the temporary gaming session is recorded at a slot accounting system or other accounting system in a fourth step 122D. In a fifth step, the player redeems the PIN/ticket at a kiosk or with an attendant. All credits are converted back to currency and all currency is returned to the player.

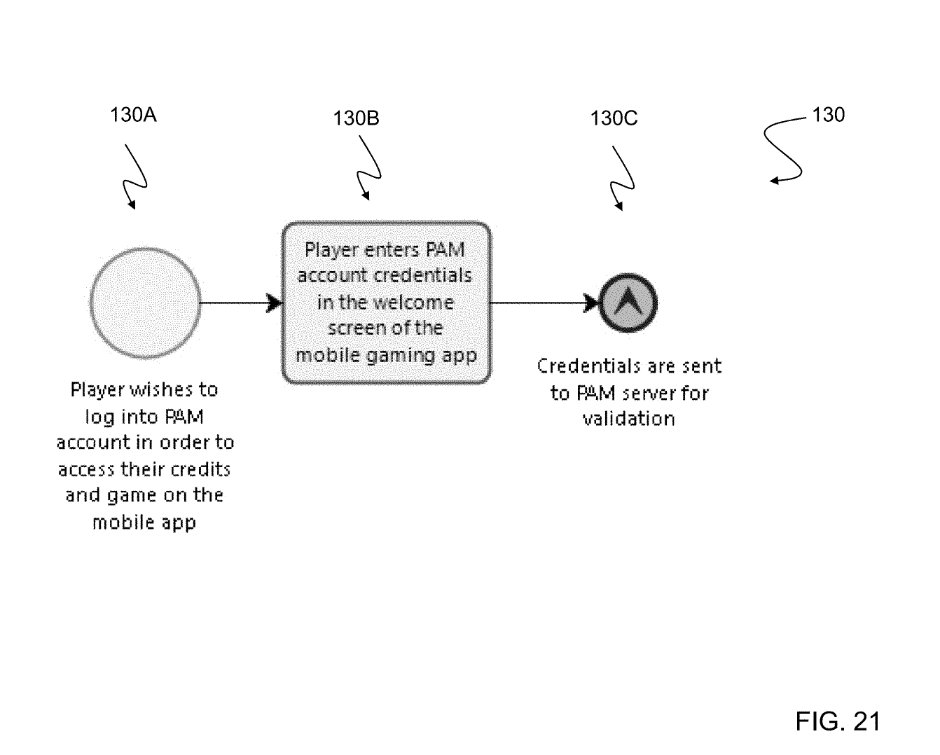

With reference to FIGS. 21-30, a number of processes related to management of a player account are illustrated. With specific reference to FIG. 21, a player account management sub-process 130 is disclosed. In the illustrated embodiment, the server system 22 includes a player account management server (not shown). In a first step 130A, in order to access their credits (converted from funds in the player account), the player may navigate to a mobile app, i.e., the player module 18 on the mobile device or phone 20. In a second step 130B, the player enters their player account management (or “PAM”) credentials into the mobile app. The credentials are then sent to the PAM server for authentication. As discussed above, once the player has logged onto their account, a first gaming session or “lobby” may be created within the user module 18 on the mobile device 20. From the lobby, the player may create one or more second gaming sessions on the one or more gaming machines 52.

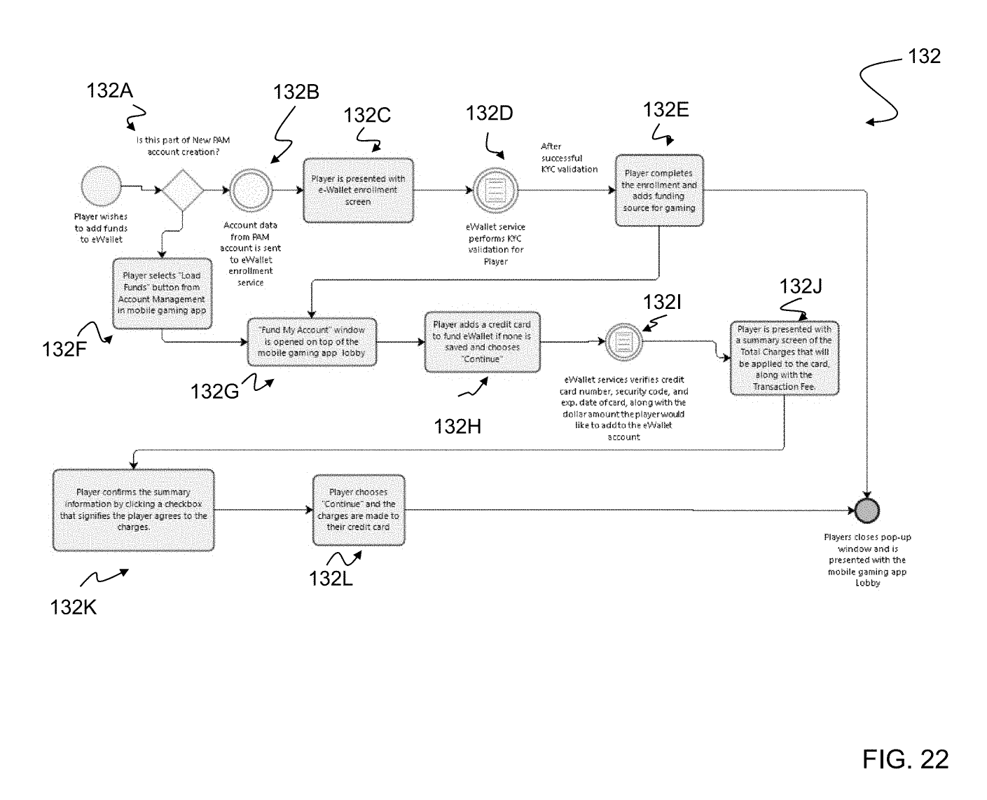

With specific reference to FIG. 22, a process 132 during which the player may add funds to the electronic wallet in the player account is shown. In a first step 132A, if the player already has an account, then the process 132, proceeds to a sixth step 132G. If the player does not have an account, then the process 132 proceeds to a second step 132B. In the second step 132B, the account credentials entered by the player are sent to an enrollment service and the player is presented with an enrollment screen in the third step 132C. In a fourth step 132D, the player's credentials are validated using, in the illustrated embodiment, using a “know your customer” or “KYC” process. In a fifth step 132E, the player completes the enrollment process and adds a funding source (see above) to their account. Then, the process 132 proceeds to the sixth step 132F.

In the sixth step 132F, the player may select “load funds” within the player module 18. In a seventh step 132G, a “Fund My Account” window or dialog is displayed. If no funding method is currently saved in the player account, the player may enter a new funding method, e.g., a credit card, in an eighth step 132H. In the ninth step 132I, if a new funding source has been added, the new funding source is verified. Additionally, the player may select or enter the amount of funds to be added to the account from the funding source. In a tenth step 132J, the player is present with a summary of the transaction, including any transaction fee. The player must confirm the transaction details (in an eleventh step 132K), prior to the method moving forward. Once the player selects “CONTINUE” in a twelfth step 132L, the player selects continue and the transaction is completed.

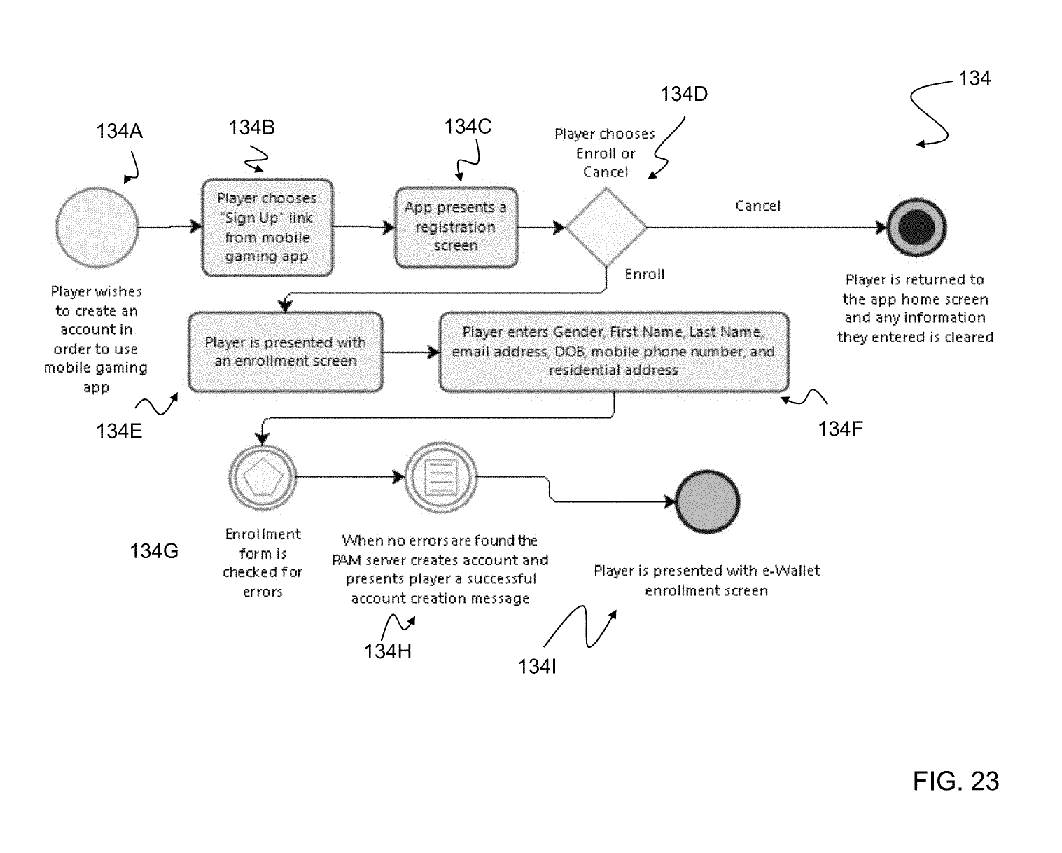

With reference to FIG. 23, a new player management account creation sub-process 134 is shown. If a new player desired to create an account, the player downloads the mobile app or player/user module 18 in a first step 134A. In a second step 134B, the player initiates the user module 18 and selects “Sign Up”. In a third step 134C, the player is presented with a registration or sign-up screen. The player can either cancel (fourth step 134D) or enroll in a fifth step 134E. In the fifth step 134E, an enrollment screen is displayed. In a sixth step 134F, the player enters registration information in a data form. The data form is checked for errors in a seventh step 134G. If no errors are found, the PAM server creates the account and a successful account creation method is displayed to the player in an eighth step 134H and the process 134 proceeds to a ninth step 134I. In the ninth step 134I, the player is presented with an electronic wallet enrollment screen.

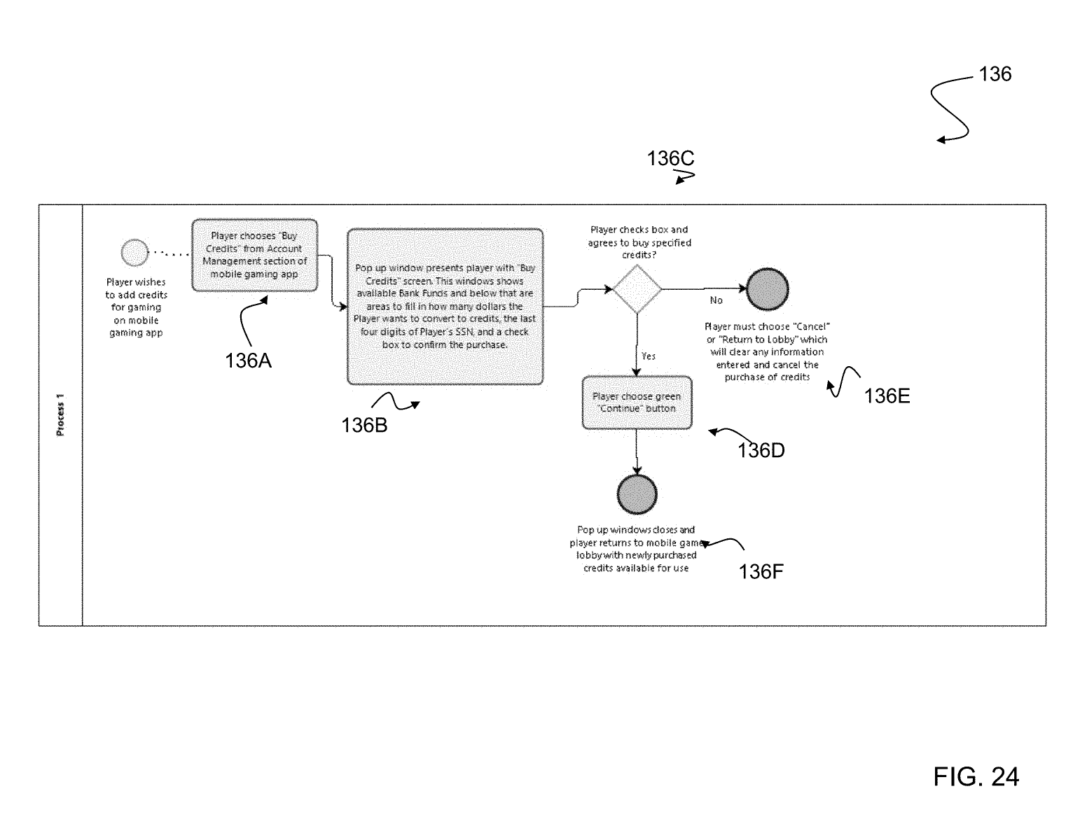

With reference to FIG. 24, once the player has created an account, funded the account and logged into the lobby, i.e., the first game session, the player may access the funds in their account stored in the server system 22 and purchase credits using a buying credits process 136. In a first step 136A, the player chooses “Buy Credits” from within the user module 18. In a second step 136B, a “Buy Credits” screen is displayed. The amount of funds available to the player from the player account is displayed. The Buy Credits screen allows the player to enter the amount of funds they would like to convert into credits. The player may also be prompted to enter a PIN, such as the last four digits of their social security number to confirm the purchase. Once the purchase has been confirmed (third step 136C), the process 136 proceeds to a fourth step 136D, If the purchase is not confirmed, then in a fifth step 136E, any entered information is cleared and the purchase is canceled. In the fourth step 136D, the player choose to continue to proceed. In a sixth step 136F, the user module 18 returns to a main lobby screen and the purchased credits are available for use.

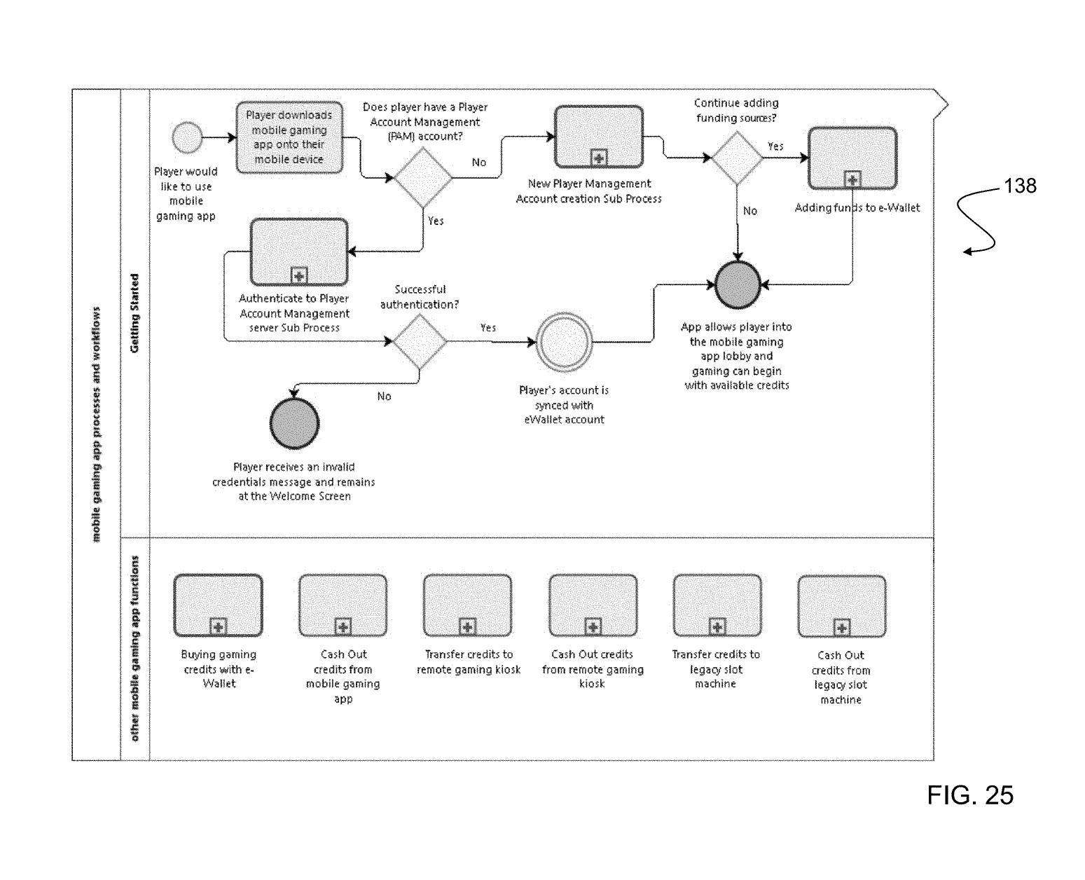

With reference to FIG. 25, a general or high-level state diagram 138 of the processes available in the lobby are shown.

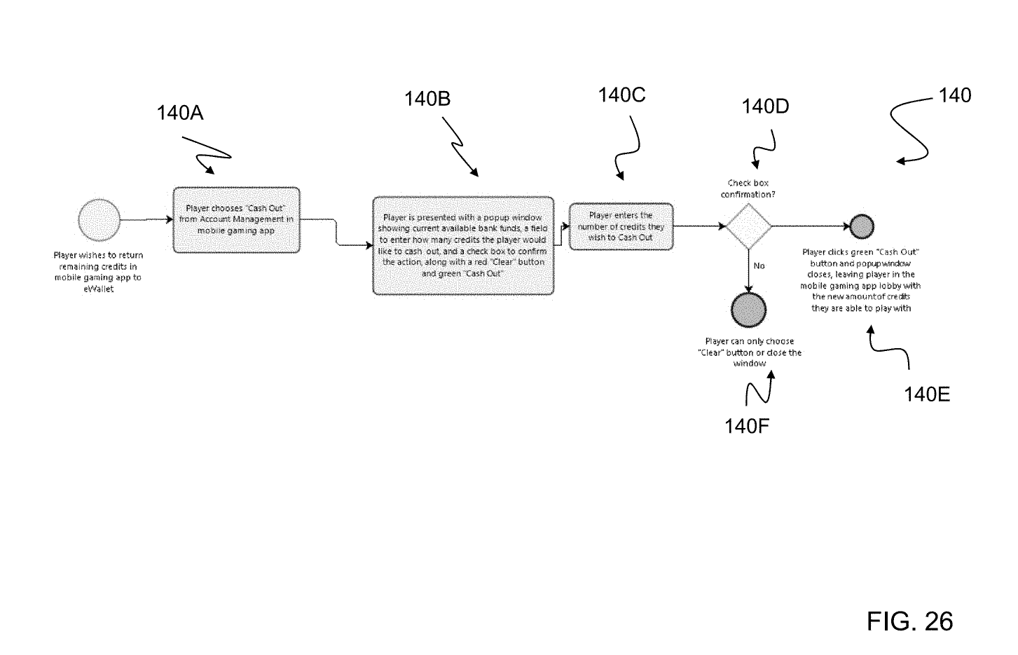

With reference to FIG. 26, a cash out credits process 140 from the user module 18 is shown. The cash out credits process 140 is used to return credits in the lobby to the electronic wallet in the player account. In a first step 140A, the player chooses “Cash Out” from the Lobby. In a second step 140B, the funds available in the player account is displayed. The player is provided the opportunity to enter the number of credits (from the first and second gaming sessions) that the player desires to return to their player account in a third step 140C. In a fourth step 140D, the player may either confirm or cancel. If the player selects to cancel, then the information is cleared (in a fifth step 140E). Otherwise, the process 140 proceeds to a sixth step 140F in which the transaction is processed and the process 140 returns to the Lobby.

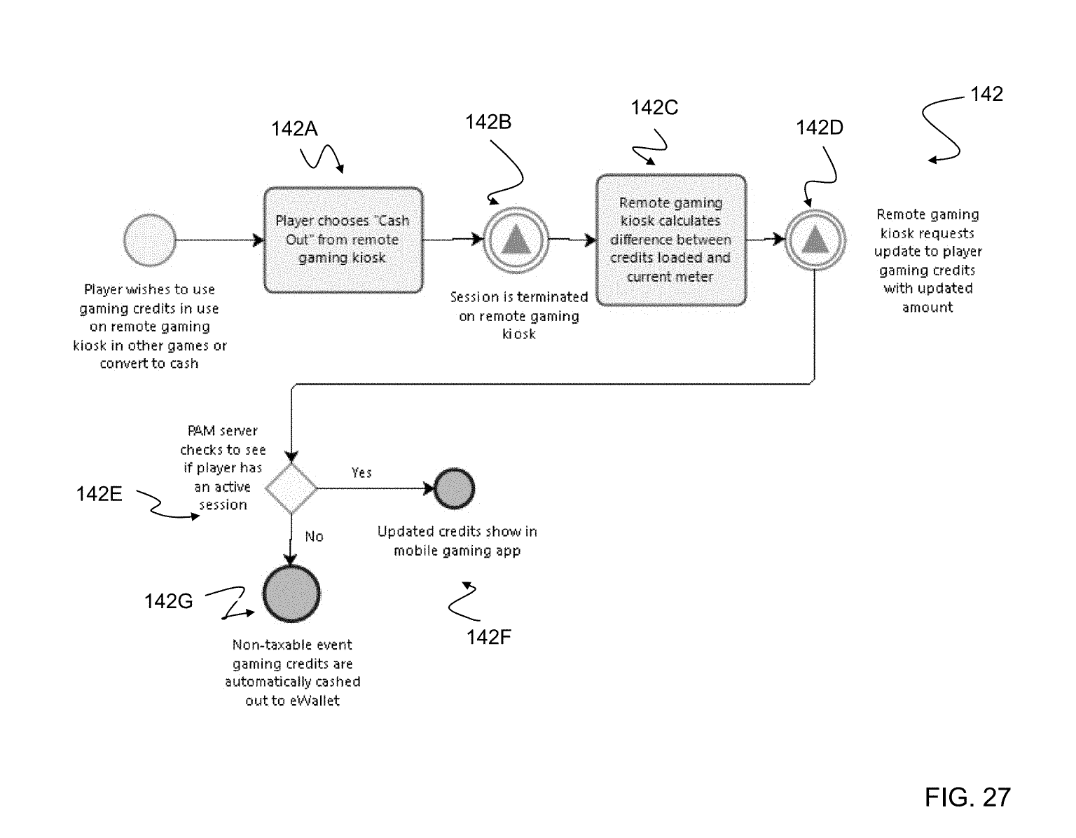

With reference to FIG. 27, a cash out credits process 142 from a remote gaming machine or kiosk is shown. As discussed above, once a first gaming session has been opened in the Lobby or user module 18, the player may open one or more second gaming sessions on other gaming machines. A remote gaming kiosk is generally a gaming machine 52 that includes a service device 12 implemented on a thin client. In a first step 142A, the player chooses “Cash Out” from the remote gaming kiosk (52). In a second step 142B, the session on the remote gaming kiosk is terminated. In a third step 142C, the remote gaming kiosk or gaming machine 52 calculates a difference between a number of credits loaded or associated with the second gaming session and the credits in the second gaming session. In a fourth step 142D, the kiosk 42 updates the number of credits in the second gaming session based on the number of credits on the credit meter. In a fifth step 142E, if there is an active first gaming session, then the process 142 proceeds to a sixth step 142F. In the sixth step 142F, the number of credits available in the first gaming session are uploaded. Otherwise, in a seventh step 142G, any (non-taxable) credits are converted back into currency and stored in the electronic wallet of the player account.

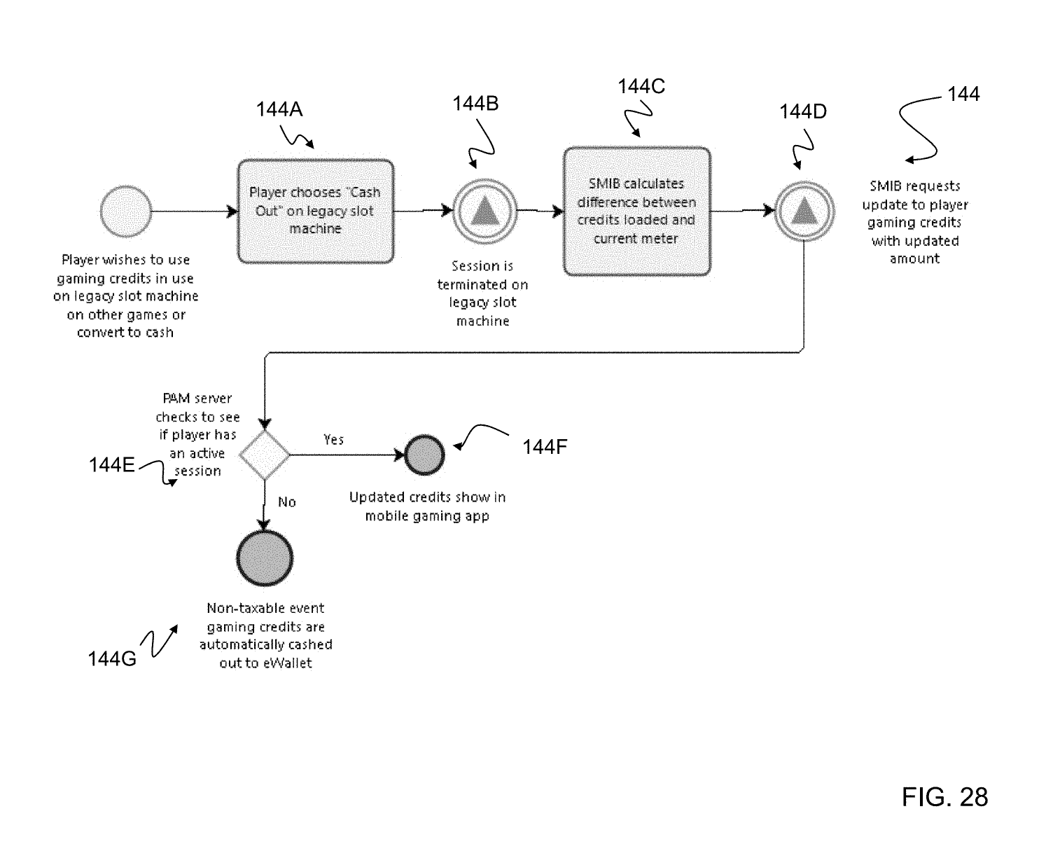

With reference to FIG. 28, a cash out credits process 144 from a legacy slot machine 52 is shown. As discussed above, once a first gaming session has been opened in the Lobby or user module 18, the player may open one or more second gaming sessions on other gaming machines. A legacy slot or gaming machine 52 has an associated service device 12 that is configured to place and remove credits onto one or more credit meters. In some embodiment, the service device 12 may emulate a bill validator and/or a ticket reader. In a first step 144A, the player chooses “Cash Out” from the legacy gaming machine (52). In a second step 144B, the session on the gaming machine 52 is terminated. In a third step 144C, the gaming machine 52 calculates a difference between a number of credits loaded or associated with the second gaming session and the credits in the second gaming session. In a fourth step 144D, the SMIB 52B (see above) updates the number of credits in the second gaming session based on the number of credits on the credit meter. In a fifth step 144E, if there is an active first gaming session, then the process 144 proceeds to a sixth step 144F. In the sixth step 144F, the number of credits available in the first gaming session are uploaded. Otherwise, in a seventh step 144G, any (non-taxable) credits are converted back into currency and stored in the electronic wallet of the player account.

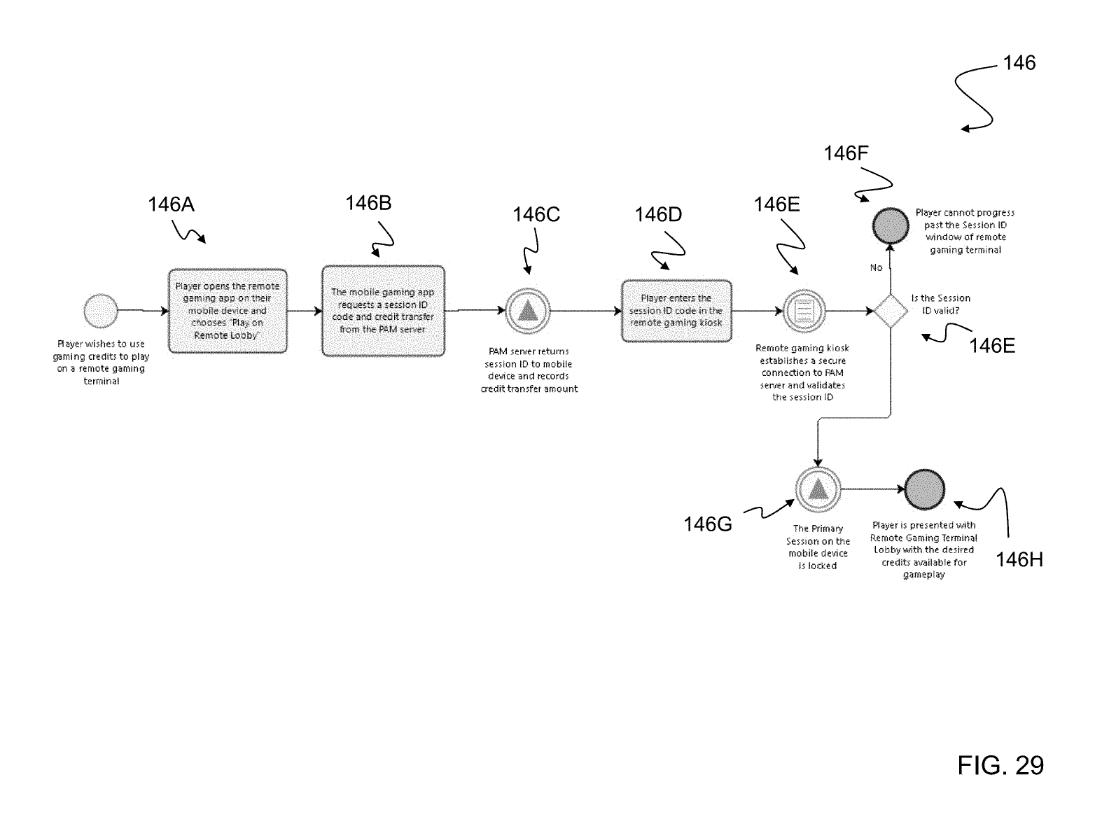

With reference to FIG. 29, a transfer credits process 146 to a remote gaming kiosk 52 is shown. As discussed above, once a first gaming session has been opened in the Lobby or user module 18, the player may open one or more second gaming sessions on other gaming machines 52. In a first step 146A, the player opens the user module 18 and select “Play on Remote Lobby”. This indicates that the player desires to open a second gaming session on another gaming machine 52. In a second step 146B, the user module 18 sends a request for a session ID code and credit transfer from the player account to the PAM server. In a third step 146C, the PAM server sends the session ID to the user module 18 and records the credit transfer in the player account. In a fourth step 146D, the player enters the session ID on the remote gaming kiosk 52. In a fifth step 146E, the remote gaming kiosk 52 attempts to validate the session ID. If the session ID is not valid, then the player cannot advance and the second gaming session cannot be opened (sixth step 146F). If the session ID is validated, then in a seventh step 146G, the primary or first gaming session on the user module 18 is locked. Alternatively, the first gaming session is not locked, however any credits transferred to the second gaming session are locked and cannot be used in the Lobby or other gaming session.

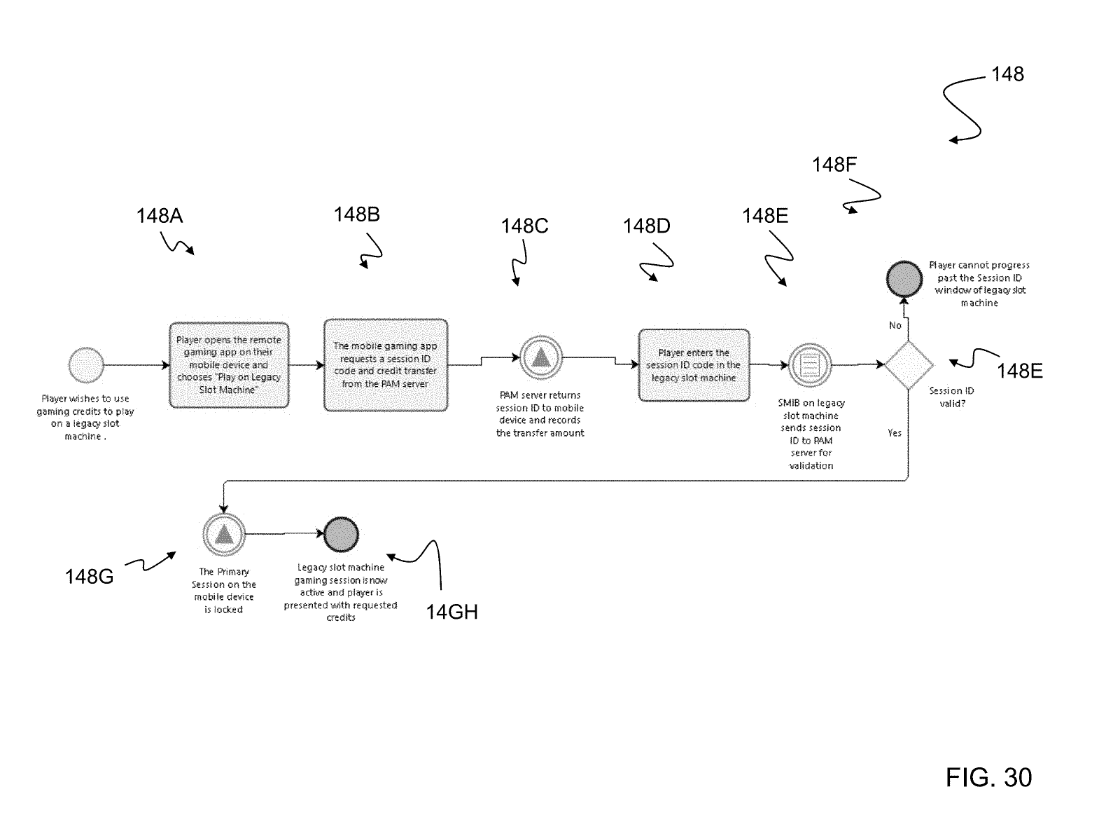

With reference to FIG. 30, a transfer credits process 148 to a legacy gaming machine or slot machine 52 is shown. As discussed above, once a first gaming session has been opened in the Lobby or user module 18, the player may open one or more second gaming sessions on other gaming machines 52. In a first step 148A, the player opens the user module 18 and select “Play on Remote Lobby”. This indicates that the player desires to open a second gaming session on another gaming machine 52. In a second step 148B, the user module 18 sends a request for a session ID code and credit transfer from the player account to the PAM server. In a third step 148C, the PAM server sends the session ID to the user module 18 and records the credit transfer in the player account. In a fourth step 148D, the player enters the session ID on the remote gaming kiosk 52. In a fifth step 148E, the remote gaming kiosk 52 attempts to validate the session ID. If the session ID is not valid, then the player cannot advance and the second gaming session cannot be opened (sixth step 148F). If the session ID is validated, then in a seventh step 148G, the primary or first gaming session on the user module 18 is locked. Alternatively, the first gaming session is not locked, however any credits transferred to the second gaming session are locked and cannot be used in the Lobby or other gaming session.

Obviously, many modifications and variations of the present invention are possible in light of the above teachings. The invention may be practiced otherwise than as specifically described within the scope of the appended claims.

1. A system for use with a gaming system, the gaming system including a plurality of gaming machines, comprising:
a database for storing a player account, the player account including funds associated with a player;
a player module associated with a mobile device;
a server system coupled to the database and the user module;
a service device coupled to the database and the server system, the service device being located at, and coupled to, a respective gaming machine, the player module configured to:
allow the player to logon and access the player account on the server system,
allow the player to request a first gaming session, the server system being responsively configured to:
open the first gaming session on the server system,
convert at least a portion of the funds in the player account to credits, and
associate the credits to the first gaming session, the player module being further configured to:
allow the player to request a second gaming session associated the gaming machine, and
authenticate the request for a second gaming session associated using the service device and the player module, wherein the server system, in response to the request being authenticated, is further configured to:
open the second gaming session,
associate at least a portion of the credits associated with the first gaming session to the second gaming session, and
transfer the credits transferred to the second gaming session to the gaming machine using the service device, wherein the player may purchase service(s) and/or good(s) in exchange for a predetermined number of credits during the gaming session, the service device being further configured to close the first and second gaming sessions on the server system and to transfer any remaining credits on the gaming machine to the server system at the close of the gaming session.

2. The system, as set forth in claim 1, wherein the server system prevents opening of a second gaming session on the server system for the player while the gaming session is open.

3. The system, as set forth in claim 1, wherein the server system allows opening of a secondary second gaming session on the server system.

4. The system, as set forth in claim 3, wherein the secondary second gaming session utilizes credits in the first gaming session that are not being utilized in the second gaming session.

5. The system, as set forth in claim 1, wherein at least one of the gaming machines is configured to provide a game of chance and/or skill.

6. The system, as set forth in claim 5, wherein the at least one of the gaming machines may provide an award to the player as a function of an outcome of the game of change and/or skill.

7. A system, as set forth in claim 1, wherein the player module is further configured to allow the player to request initiation of the second gaming session and to send the request to the server system, the server system being configured to generate an access code in response to receiving the request from the user module and to send the access code back to the player module.

8. A system, as set forth in claim 7, wherein the service device is are configured to receive the access code and to responsively send a request authorization message to the server system.

9. A system, as set forth in claim 8, wherein the server system is configured to receive the request authorization message and to send a confirmation request to the player module and to responsively open the second game session on the server system for use with gaming machine associated with the service device in response to receiving authorization from the player module.

10. A system, as set forth in claim 1, wherein the service device 12, in response to an occurrence of a taxable event, removes associated taxable credits from the first and second gaming sessions, converts the removed taxable credits to funds and stores the funds in the player account in the database.

11. A method for operating a system, the system including a database, a player module associated with a mobile device, and a service device coupled to the database and the server system, the service device being located at, and coupled to, a gaming machine, the method including the steps of:
allowing the player, using the player module, to logon and access the player account on the server system and to allow the player to request a first gaming session;
in response to receiving the request to open the first gaming session, opening, by the server system, the first gaming session;
converting at least a portion of the funds in the player account to credits;
associating the credits with the first gaming session;
allowing the player to request a second gaming session on the server system associated with the gaming machine, and
authenticating the request for a second gaming session using the service device and the player module;
responsively opening, by the server system, the second gaming session;
associate at least a portion of the credits associated with the first gaming session to the second gaming session, and
transferring the credits associated with the second gaming session to the gaming machine using the service device, wherein the player may purchase service(s) and/or good(s) in exchange for a predetermined number of credits during the gaming session, the service device being further configured to close the first and second gaming sessions on the server system and to transfer any remaining credits on the gaming machine to the server system at the close of the gaming session.

12. The method, as set forth in claim 11, including the step of preventing, by the server system prevents, opening of a secondary second gaming session on the server system for the player while the gaming session is open.

13. The method, as set forth in claim 11, including the step of allowing opening of a secondary second gaming session on the server system.

14. The method, as set forth in claim 13, wherein the secondary second gaming session utilizes credits in the first gaming session that are not being utilized in the second gaming session.

15. The method, as set forth in claim 11, wherein at least one of the gaming machines is configured to provide a game of chance and/or skill.

16. The method, as set forth in claim 15, wherein the at least one of the gaming machines may provide an award to the player as a function of an outcome of the game of change and/or skill.

17. The method, as set forth in claim 13, the method including the steps of:
allowing the player to request initiation of the second gaming session;
sending the request for initiation of the second gaming session to the server system;
generating an access code in response to receiving the request from the user module; and,
sending the access code back to the player module.

18. A method, as set forth in claim 17, including the steps of receiving the access code and to responsively sending a request authorization message to the server system.

19. A method, as set forth in claim 18, including the steps of:
receiving, at the server system, the request authorization message;
responsively sending a confirmation request to the player module; and,
responsively opening the second game session on the server system for use with gaming machine associated with the service device in response to receiving authorization from the player module.

20. A method, as set forth in claim 1, further include the steps of detecting an occurrence of a taxable event, removing associated taxable credits from the first and second gaming sessions, converting the removed taxable credits to funds and storing the funds in the player account in the database.
